(19) United States
(12) Patent Application Publication
(10) Pub. No.: US 2025/0201820 A1
(43) Pub. Date: Jun. 19, 2025

(54) CARBON COATED SnO2/TiO2 ELECTRODE MATERIALS

(71) Applicant: The Board of Regents of The University of Texas System, Austin, TX (US)

(72) Inventors: Mataz Alcoutlabi, Edinburg, TX (US); Ali Ashraf, Edinburg, TX (US)

(21) Appl. No.: 18/979,796

(22) Filed: Dec. 13, 2024

Related U.S. Application Data
(60) Provisional application No. 63/610,238, filed on Dec. 14, 2023.

(51) Int. Cl. H01M 4/36; H01M 4/02; H01M 4/04; H01M 4/48; H01M 10/0525

(52) U.S. Cl. CPC H01M 4/366; H01M 4/0428; H01M 4/0471; H01M 4/483; H01M 10/0525; H01M 2004/021; H01M 2004/027

(57) ABSTRACT

The present disclosure provides novel processes for producing carbon coated SnO₂ and TiO₂ electrode materials by chemically vapor depositing carbon. The novel processes described herein yield electrode materials with improved electrochemical properties.

### CROSS REFERENCE TO RELATED APPLICATION

This application which claims benefit under 35 U.S.C. § 119(e) of Provisional U.S. Patent Application No. 63/610,238, filed Dec. 14, 2023, the contents of which are hereby incorporated by reference in its entirety.

### GOVERNMENT RIGHTS

This invention was made with government support under DMR-2122178 awarded by the National Science Foundation. The government has certain rights in the invention.

### TECHNICAL FIELD

The description provides carbon-coated tin oxide and titanium oxide (SnO₂/TiO₂) electrode materials, whereby the carbon coating is provided by chemical vapor deposition (CVD). The coated electrode materials described herein exhibit improved electrochemical performance compared to uncoated electrode materials.

### BACKGROUND OF THE INVENTION

The world's reliance on fossil fuels has significantly affected the climate crisis. In response, lithium-ion batteries (LIBs) have emerged as a promising alternative to help reduce our dependence on these non-renewable resources and transition towards a cleaner, more sustainable energy future. Rechargeable LIBs have gained widespread use in electronics, electric vehicles, and grid storage systems due to their high energy density and specific power [1, 2].

The use of graphite as the anode material is limited by its low capacity and poor rate performance due to the growth of dendrites [3]. As a result, significant research has been conducted into alternative anode materials for LIBs such as silicon, tin, and graphene.

Silicon (Si) is a potential material as an anode due to its low discharge potential and high capacity for lithium storage with a theoretical capacity of approximately 4,200 mAh g⁻¹, which is more than ten times higher than that of graphite (372 mAh g⁻¹) [4, 5]. However, Si suffers from significant volume expansion upon lithium insertion, which can lead to mechanical failure of the anode. Researchers have explored Si-based composite materials and Si nanostructures to overcome this limitation, which can mitigate the volume expansion issue [6-8].

Tin (Sn) also has a high lithium storage capacity of 994 mAh g⁻¹ but suffers from significant volume expansion similar to silicon, which causes the anode to pulverize and lowers its cyclability [9, 10]. To overcome this limitation tin-based nanostructures and oxidized tin materials were synthesized and used as anodes in LIBs [11] and have used [12-14].

Graphene with a single layer of carbon atoms arranged in a hexagonal lattice has also been used as an alternative anode because of it has high electrical conductivity and high capacity [15-17]. However, the high production rate and cost of graphene results in difficulties for its use as anode in LIBs [18].

There exists a need in the art for more economically competitive carbon coating processes that lead to improved electrochemical performance of electrode materials.

### SUMMARY OF THE INVENTION

The present disclosure is directed to a method of making an electrode, comprising depositing, by chemical vapor deposition, a carbon coating on an electrode material comprising at least one of SnO₂ and TiO₂.

The present disclosure is directed to a method of making an electrode material comprising SnO₂ and TiO₂, the method comprising centrifugal spinning of a mixture of a precursor solution comprising polyvinylpyrrolidone (PVP), SnO₂ and TiO₂.

The present disclosure is directed to an electrode material comprising SnO₂ and TiO₂, wherein the electrode material comprises a coating of pyrolytic carbon.

The present disclosure is directed to an electrode material comprising SnO₂ and TiO₂, wherein the electrode material is in a nanobelt form; optionally wherein the nanobelt comprises a coating of pyrolytic carbon.

The present disclosure is directed to an anode made by any of the methods described herein.

The present disclosure is directed to a lithium ion battery comprising an anode made by any of the methods described herein.

### BRIEF DESCRIPTION OF THE DRAWINGS

FIG. 1a depicts SEM images of pristine PVP/SnO₂. FIG. 1d depicts a histogram corresponding to FIG. 1a. FIG. 1b depicts SEM images of PVP/TiO₂. FIG. 1e depicts a histogram corresponding to FIG. 1b. FIG. 1c depicts SEM images of PVP/SnO₂/TiO₂ (3:1) precursor fibers. FIG. if depicts a histogram corresponding to FIG. 1c.

FIG. 2 depicts SEM images of SnO₂/TiO₂ (3:1) calcined fibers at 2,000× magnification.

FIG. 3 depicts EDS mapping of SnO₂/TiO₂ (3:1) calcined micro-belts.

FIG. 4 depicts TGA data for PVP/SnO₂/TiO₂ (3:1) fibers.

FIG. 5a depicts cyclic voltametric curves of SnO₂. FIG. 5b depicts cyclic voltametric curves of TiO₂. FIG. 5c depicts cyclic voltametric curves of SnO₂/TiO₂ (3:1). FIG. 5d depicts cyclic voltametric curves of SnO₂, TiO₂, and SnO₂/TiO₂ (3:1).

FIG. 6 depicts rate performance of SnO₂, TiO₂, and SnO₂/TiO₂ (3:1).

FIG. 7a depicts charge/discharge curves at 1^{st} cycle. FIG. 7b depicts charge/discharge curves at 100^{th} cycle. FIG. 7c depicts charge/discharge curves at charge specific capacity for 100 cycles. FIG. 7d depicts charge/discharge curves for coulombic efficiency of SnO₂, TiO₂, and SnO₂/TiO₂ (3:1).

FIG. 8a depicts electrochemical impedance spectroscopy data of a fitted Nyquist plot for SnO₂, TiO₂, and SnO₂/TiO₂ (3:1). FIG. 8b depicts electrochemical impedance spectroscopy data of a fitted Warburg plot for SnO₂, TiO₂, and SnO₂/TiO₂ (3:1). FIG. 8c depicts an equivalent circuit for SnO₂. FIG. 8d depicts an equivalent circuit for TiO₂. FIG. 8e depicts an equivalent circuit for SnO₂/TiO₂ (3:1).

FIG. 9a depicts SEM images of SnO₂/TiO₂ (3:1) CVD after 30 minutes at 500× magnification. FIG. 9b depicts SEM images of SnO₂/TiO₂ (3:1) CVD after 60 minutes at 500× magnification. FIG. 9c depicts SEM images of SnO₂/TiO₂ (3:1) CVD after 30 minutes at 2000× magnification. FIG. 9d depicts SEM images of SnO₂/TiO₂ (3:1) CVD after 60 minutes at 2000× magnification. FIG. 9e depicts SEM images of SnO₂/TiO₂ (3:1) CVD after 30 minutes at 5000× magnification. FIG. 9f depicts SEM images of SnO₂/TiO₂ (3:1) CVD after 60 minutes at 5000× magnification. FIG. 9g depicts SEM images of SnO₂/TiO₂ (3:1) CVD after 30 minutes at 10000× magnification. FIG. 9h depicts SEM images of SnO₂/TiO₂ (3:1) CVD after 60 minutes at 10000× magnification.

FIG. 10 depicts EDS mapping of SnO₂/TiO₂ (3:1) CVD for 30 minutes.

FIG. 11 depicts EDS mapping of SnO₂/TiO₂ (3:1) CVD for 60 minutes.

FIG. 12 depicts EDS mapping of SnO₂/TiO₂ (3:1) heat treated at 1000° C. under argon without methane.

FIG. 13a depicts XRD analysis of SnO₂/TiO₂ (3:1) CVD combined. FIG. 13b depicts XRD analysis after 60 minutes.

FIG. 14a depicts XPS analysis of Ti 2P_{1/2} and Ti 2P_{3/2} spectra for SnO₂/TiO₂ (3:1) CVD for 30 minutes. FIG. 14b depicts XPS analysis of Ti 2P_{1/2} and Ti 2P_{3/2} spectra for SnO₂/TiO₂ (3:1) CVD for 60 minutes.

FIG. 15a depicts XPS analysis of Sn 3d_{5/2} and Sn 3d_{3/2} spectra of SnO₂/TiO₂ (3:1) CVD after 30 minutes. FIG. 15b depicts XPS analysis of Sn 3d_{5/2} and Sn 3d_{3/2} spectra of SnO₂/TiO₂ (3:1) CVD for 60 minutes.

FIG. 16a depicts XPS analysis of CIS spectra for SnO₂/TiO₂ (3:1) CVD after 30 minutes. FIG. 16b depicts XPS analysis of CIS spectra for SnO₂/TiO₂ (3:1) CVD for 60 minutes (FIG. 16b).

FIG. 17a depicts XPS analysis of OS spectra for SnO₂/TiO₂ (3:1) CVD after 30 minutes. FIG. 17b depicts XPS analysis of OS spectra for SnO₂/TiO₂ (3:1) CVD for 60 minutes.

FIG. 18a depicts charge/discharge curves of SnO₂/TiO₂ (3:1) CVD 0-, 30-, and 60-minutes of 1^{st} cycle. FIG. 18b depicts charge/discharge curves of SnO₂/TiO₂ (3:1) CVD 0-, 30-, and 60-minutes of 100^{th} cycles. FIG. 18c depicts charge specific capacity cycle performances. FIG. 18d depicts Coulombic efficiency over 100 cycles at a current density of 100 mA g⁻¹.

FIG. 19 depicts rate performance data for SnO₂/TiO₂ (3:1) CVD 0-, 30-, and 60-minutes at current densities of 50, 100, 200, 400, 500, and 50 mA g⁻¹.

FIG. 20a depicts cyclic voltammetry of the first three cycles for SnO₂/TiO₂ (3:1) CVD for 0 minutes. FIG. 20b depicts cyclic voltammetry of the first three cycles for SnO₂/TiO₂ (3:1) CVD for 30 minutes. FIG. 20c depicts cyclic voltammetry of the first three cycles for SnO₂/TiO₂ (3:1) CVD for 60 minutes. FIG. 20d depicts cyclic voltammetry of the first cycles of all three samples.

FIG. 21a depicts EIS data of fitted Nyquist plot for SnO₂/TiO₂ (3:1) CVD 0-, 30-, and 60-minutes. FIG. 21b depicts EIS data of fitted Warburg plot for SnO₂/TiO₂ (3:1) CVD 0-, 30-, and 60-minutes.

FIG. 22a depicts SEM images of calcined SnO₂/TiO₂ (1:1) fibers at rates of 1° C./min.

FIG. 22b depicts SEM images of calcined SnO₂/TiO₂ (1:1) fibers at rates of 3° C./min. FIG. 22c depicts SEM images of calcined SnO₂/TiO₂ (1:1) fibers at rates of 3.3° C./min. FIG. 22d depicts SEM images of calcined SnO₂/TiO₂ (2:1) fibers at rates of 1.1° C./min. FIG. 22e depicts SEM images of calcined SnO₂/TiO₂ (2:1) fibers at rates of 1.3° C./min. FIG. 22f depicts SEM images of calcined SnO₂/TiO₂ (2:1) fibers at rates of 1.5° C./min. FIG. 22g depicts SEM images of calcined SnO₂/TiO₂ (3:1) fibers at rates of 0.5° C./min. FIG. 22h depicts SEM images of calcined SnO₂/TiO₂ (3:1) fibers at rates of 0.6° C./min. FIG. 22i depicts SEM images of calcined SnO₂/TiO₂ (3:1) fibers at rates of 1.0° C./min. FIG. 22j depicts SEM images of calcined SnO₂/TiO₂ (3:2) fibers at rates of 1.5° C./min. FIG. 22k depicts SEM images of calcined SnO₂/TiO₂ (3:2) fibers at rates of 2.0° C./min. FIG. 22l depicts SEM images of calcined SnO₂/TiO₂ (3:2) fibers at rates of 2.5° C./min.

### DETAILED DESCRIPTION OF ILLUSTRATIVE EMBODIMENTS

Unless otherwise defined, all technical and scientific terms used herein have the same meaning as commonly understood by one of ordinary skill in the art to which this disclosure pertains. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (e.g., to at least one) of the grammatical object of the article unless the context clearly indicates otherwise. By way of example, “an element” means one element or more than one element.

As used herein, the term “pyrolytic carbon” is taken to mean a carbon material deposited from gaseous hydrocarbon compounds on suitable underlying substrates at temperatures ranging from 1000 to 2500 K (CVD). Suitable substrates include, but are not limited to, carbon materials, metals, ceramics and combinations thereof.

As used herein, the term “fibrous mat” is taken to mean a collection of fibers that are comprised in a non-woven fabric made out of fibers that are held together by chemical or physical means.

According to the disclosure, the invention is directed to a method of making an electrode, comprising depositing, by chemical vapor deposition, a carbon coating on an electrode material comprising at least one of SnO₂ and TiO₂.

In some embodiments, the carbon coating comprises pyrolytic carbon. In some embodiments, the carbon coating is pyrolytic carbon. In some embodiments, the coating of pyrolytic carbon comprises a single layer of pyrolytic carbon. In other embodiments, the coating of pyrolytic carbon comprises multiple layers of pyrolytic carbon.

In some embodiments, the chemical vapor deposition comprises contacting the electrode material with hydrocarbon gas. In some embodiments, the hydrocarbon gas is methane gas.

In some embodiments, the chemical vapor deposition takes place for about 10 minutes to about 60 minutes. In some embodiments, the chemical vapor deposition takes place for about 60 minutes or less; or for about 55 minutes or less; or for about 50 minutes or less; or for about 45 minutes or less; or for about 40 minutes or less; or for about 35 minutes or less; or for about 30 minutes or less; or for about 25 minutes or less; or for about 20 minutes or less; or for about 15 minutes or less; or for about 10 minutes or less; or for about 5 minutes or less.

In some embodiments, the chemical vapor deposition takes place for about 5 minutes to about 10 minutes; or from about 10 minutes to about 15 minutes; or from about 15 minutes to about 20 minutes; or from about 20 minutes to about 25 minutes; or from about 25 minutes to about 30 minutes; or from about 30 minutes to about 35 minutes; or from about 35 minutes to about 40 minutes; or from about 40 minutes to about 45 minutes; or from about 45 minutes to about 50 minutes; or from about 50 minutes to about 55 minutes; or from about 55 minutes to about 60 minutes; or from about 60 minutes to about 65 minutes.

In some embodiments, the electrode material is heated to a range of from about 800° C. to 1200° C. prior to the chemical vapor deposition of the carbon coating. In some embodiments, the electrode material is heated to a range of from about 900° C. to 1100° C. prior to the chemical vapor deposition of the carbon coating. In other embodiments, the electrode material is heated to a range of from about 950° C. to 1050° C. prior to the chemical vapor deposition of the carbon coating. In some embodiments, the electrode material is heated to about 1000° C. prior to the chemical vapor deposition of the carbon coating.

In some embodiments, the carbon coating has a thickness of about 5 nm to about 50 nm. In some embodiments, the carbon coating has a thickness of about 10 nm to about 40 nm. In other embodiments, the carbon coating has a thickness of about 15 nm to about 30 nm. In other embodiments, the carbon coating has a thickness of about 20 nm to about 30 nm.

In some embodiments, the carbon coating has a thickness of from about 5 nm to about 10 nm; or from about 10 nm to about 15 nm; or from about 15 nm to about 20 nm; or from about 20 nm to about 25 nm; or from about 25 nm to about 30 nm; or from about 30 nm to about 35 nm; or from about 35 nm to about 40 nm; or from about 40 nm to about 45 nm; or from about 45 nm to about 50 nm; or from about 50 nm to about 55 nm.

In some embodiments, the carbon coating has a thickness of about 50 nm or less. In some embodiments, the carbon coating has a thickness of about 45 nm or less. In some embodiments, the carbon coating has a thickness of about 40 nm or less. In other embodiments, the carbon coating has a thickness of about 35 nm or less. In other embodiments, the carbon coating has a thickness of about 30 nm or less. In other embodiments, the carbon coating has a thickness of about 25 nm or less. In other embodiments, the carbon coating has a thickness of about 20 nm or less. In yet other embodiments, the carbon coating has a thickness of about 15 nm or less. In yet other embodiments, the carbon coating has a thickness of about 10 nm or less. In yet other embodiments, the carbon coating has a thickness of about 5 nm or less.

In some embodiments, the electrode material comprises both SnO₂ and TiO₂. In some embodiments, the electrode material is a short fiber.

According to the disclosure, the invention is directed to a method of making an electrode that further comprises preparing the short fiber by centrifugal spinning of a mixture of a precursor solution comprising polyvinylpyrrolidone (PVP), SnO₂ and TiO₂.

In some embodiments, the precursor solution comprises a SnO₂/TiO₂ ratio of about 1:1. In some embodiments, the precursor solution comprises a SnO₂/TiO₂ ratio of about 2:1. In other embodiments, the precursor solution comprises a SnO₂/TiO₂ ratio of about 3:1. In other embodiments, the precursor solution comprises a SnO₂/TiO₂ ratio of about 4:1. In other embodiments, the precursor solution comprises a SnO₂/TiO₂ ratio of about 5:1.

In some embodiments, the method further comprises heat treating the precursor solution after the centrifugal spinning to produce a fibrous mat. In some embodiments, the heat treating comprises placing the fibrous mat in a drying oven.

In some embodiments, the method further comprises calcinating the fibrous mat to produce the short fiber. In some embodiments, the calcinating comprises heating the fibrous mat for about 3 hours.

In other embodiments, the fibrous mat is heated to a range of from about 500° C. to 1000° C. during the calcinating. In other embodiments, the fibrous mat is heated to a range of from about 600° C. to 800° C. during the calcinating. In other embodiments, the fibrous mat is heated to a range of from about 650° C. to 750° C. during the calcinating. In some embodiments, the fibrous mat is heated to about 700° C.

In other embodiments, the heating comprises heating the fibrous mat for about 1 hour to about 5 hours. In other embodiments, the heating comprises heating the fibrous mat for about 2 hours to about 4 hours. In other embodiments, the heating comprises heating the fibrous mat for about 2.5 hours to about 3.5 hours. In some embodiments, the fibrous mat is heated for about 3 hours.

In some embodiments, the calcinating comprises heating the fibrous mat to about 700° C. for about 3 hours.

In some embodiments, the short fiber has a length of about 0.5 μm to about 5 μm. In some embodiments, the short fiber has a length of about 1 μm to about 4 μm. In other embodiments, the short fiber has a length of about 1.5 to about 3 μm. In other embodiments, the short fiber has a length of about 2 to about 2.5 μm.

In some embodiments, the short fiber has a length of about 0.5 μm to about 1 μm; or from about 1 μm to about 1.5 μm; or from about 1.5 μm to about 2 μm; or from about 2 μm to about 2.5 μm; or from about 2.5 μm to about 3 μm; or from about 3 μm to about 3.5 μm; or from about 3.5 μm to about 4 μm; or from about 4 μm to about 4.5 μm.

In some embodiments, the short fiber has a length of about 4 μm or less. In some embodiments, the short fiber has a length of about 3.5 μm or less. In some embodiments, the short fiber has a length of about 3 μm or less. In other embodiments, the short fiber has a length of about 2.5 μm or less. In other embodiments, the short fiber has a length of about 2 μm or less.

In other embodiments, the short fiber has a length of about 1.5 μm or less. In yet other embodiments, the short fiber has a length of about 1 μm or less. In yet other embodiments, the short fiber has a length of about 0.5 μm or less.

According to the disclosure, the invention is directed to an electrode material that is an anode. In some embodiments, the anode is made by any of the methods described herein. In some embodiments, a lithium ion battery comprises an anode made by any of the methods described herein.

According to the disclosure, the invention is directed to a method of making an electrode material comprising SnO₂ and TiO₂, the method comprising centrifugal spinning of a mixture of a precursor solution comprising polyvinylpyrrolidone (PVP), SnO₂ and TiO₂.

In some embodiments, the method of making an electrode material comprising SnO₂ and TiO₂ further comprises heat treating the precursor solution after the centrifugal spinning to produce a fibrous mat.

In some embodiments, the method of making an electrode material comprising SnO₂ and TiO₂ further comprises calcinating the fibrous mat to produce the electrode material.

In some embodiments, the method of making an electrode material comprising SnO₂ and TiO₂ further comprises heating the fibrous mat to about 700° C. for about 3 hours.

In some embodiments, the method of making an electrode material comprising SnO₂ and TiO₂ further comprises depositing a layer of carbon on the electrode material.

According to the disclosure, the invention is directed to an electrode material comprising SnO₂ and TiO₂, wherein the electrode material comprises a coating of pyrolytic carbon.

### Aspects of the Invention

The disclosure is directed to the following aspects:
Aspect 1. A method of making an electrode, comprising:
   depositing, by chemical vapor deposition, a carbon coating on an electrode material comprising at least one of SnO₂ and TiO₂.
Aspect 2. The method of aspect 1, wherein the carbon coating comprises pyrolytic carbon.
Aspect 3. The method of aspect 1 or aspect 2, wherein the electrode material comprises both SnO₂ and TiO₂.
Aspect 4. The method of any one of the preceding aspects, wherein the electrode material is a short fiber.
Aspect 5. The method of aspect 4, further comprising preparing the short fiber by centrifugal spinning of a mixture of a precursor solution comprising polyvinylpyrrolidone (PVP), SnO₂ and TiO₂.
Aspect 6. The method of aspect 5, further comprising heat treating the precursor solution after the centrifugal spinning to produce a fibrous mat.
Aspect 7. The method of aspect 6, further comprising calcinating the fibrous mat to produce the short fiber.
Aspect 8. The method of aspect 5, wherein the precursor solution comprises a SnO₂/TiO₂ ratio of about 3:1.
Aspect 9. The method of any one of the preceding aspects, wherein the chemical vapor deposition takes place for about 30 minutes.
Aspect 10. The method of any one of aspects 1-8, wherein the chemical vapor deposition takes place for about 60 minutes or less.
Aspect 11. The method of any one of the preceding aspects, wherein the calcinating comprises heating the fibrous mat to about 700° C. for about 3 hours.
Aspect 12. The method of any one of the preceding aspects, wherein the electrode material is heated to about 1000° C. prior to the chemical vapor deposition of the carbon coating.
Aspect 13. The method of any one of the preceding aspects, wherein the chemical vapor deposition comprises contacting the electrode material with methane gas.
Aspect 14. The method of any one of the preceding aspects, wherein the carbon coating has a thickness of about 5 nm to about 50 nm.
Aspect 15. The method of any one of the preceding aspects, wherein the carbon coating has a thickness of about 50 nm or less.
Aspect 16. The method of any one of the preceding aspects, wherein the short fiber has a length of about 1 μm to about 4 μm.
Aspect 17. The method of any one of aspects 1-15, wherein the short fiber has a length of about 4 μm or less.
Aspect 18. The method of any one of the preceding aspects, wherein the electrode material is an anode.
Aspect 19. An anode made by the method of any one of the preceding aspects.
Aspect 20. A lithium ion battery comprising an anode made by the method any one of aspects 1-18.

The disclosure is also directed to the following aspects:
Aspect 21. A method of making an electrode material comprising SnO₂ and TiO₂, the method comprising centrifugal spinning of a mixture of a precursor solution comprising polyvinylpyrrolidone (PVP), SnO₂ and TiO₂.
Aspect 22. The method of aspect 21, further comprising heat treating the precursor solution after the centrifugal spinning to produce a fibrous mat.
Aspect 23. The method of aspect 22, further comprising calcinating the fibrous mat to produce the electrode material.
Aspect 24. The method of aspect 23, wherein the calcinating comprises heating the fibrous mat to about 700° C. for about 3 hours.
Aspect 25. The method of any one of aspects 21-24, further comprising depositing a layer of carbon on the electrode material.
Aspect 26. The method of any one of aspects 21-25, wherein the layer of carbon is a pyrolytic layer of carbon.
Aspect 27. The method of any one of aspects 21-26, wherein the depositing comprises depositing by chemical vapor deposition.
Aspect 28. The method of any one of aspects 21-27, wherein the electrode material is a short fiber.
Aspect 29. The method of aspect 28, wherein the short fiber has a length of about 1 μm to about 4 μm.
Aspect 30. The method of aspect 28, wherein the short fiber has a length of about 4 μm or less.
Aspect 31. The method of any one of aspects 21-30, wherein the electrode material is an anode.
Aspect 32. An anode made by the method of any one of aspects 21-30.
Aspect 33. A lithium ion battery comprising an anode made by the method of any one of aspects 21-30.

The disclosure is also directed to the following aspects:
Aspect 34. An electrode material comprising SnO₂ and TiO₂, wherein the electrode material comprises a coating of pyrolytic carbon.
Aspect 35. The electrode material of aspect 34, wherein the electrode material is a short fiber.
Aspect 36. The electrode material of aspect 34 or aspect 35, wherein the carbon coating has a thickness of about 5 nm to about 50 nm.
Aspect 37. The electrode material of any one of aspects 34-36, wherein the carbon coating has a thickness of about 50 nm or less.

The disclosure is also directed to the following aspects:
Aspect 38. An electrode material comprising SnO₂ and TiO₂, wherein the electrode material is in a nanobelt form; optionally wherein the nanobelt comprises a coating of pyrolytic carbon.

Compounds of the invention can be prepared using numerous preparatory reactions known in the literature. The following Examples are provided to illustrate some of the concepts described within this disclosure. While the Examples are considered to provide an embodiment, it should not be considered to limit the more general embodiments described herein.

### EXAMPLES

### General Procedures

### Materials

Poly acrylonitrile (PAN) (Mw 150,000), polyvinylpyrrolidone (PVP) (Mw˜1,300,000), Super P carbon black, ethylene carbonate (EC), dimethyl carbonate (DMC), tin (II) 2-ethyl-hexanoate, and titanium (IV) butoxide (reagent grade, 97%) were purchased from Sigma Aldrich and used as received. N, N-dimethyl formamide (DMF), and absolute ethanol (200 proof) were purchased from Fisher Chemical and were used as received. Whatman glass microfibers were used as separators in li-ion battery half-cells and were purchased from GE Healthcare. Commercial lithium metal and lithium salt (LiPF₆) were purchased from MTI, USA.

### Preparation of Micro-Belt Short Fibers

20-gram solutions of ethanol and PVP with weight concentrations of 85% and 15%, respectively, were prepared to obtain long fibers. SnO₂ and TiO₂ precursors were mixed with 50 wt. % PVP to prepare solutions with 4 different SnO₂ to TiO₂ ratios:(1:1), (2:1), (3:1), and (3:2). The solutions were magnetically stirred for 24 hours and then centrifugally spun using a spinneret equipped with 30-gauge needles. Rotational speeds of 9000 rpm were used at 2 min intervals until the 20-gram solutions were spun completely. The fibrous mats were collected and dried at room temperature for 24 hrs. The mats were then placed in an oven to be calcined at 700° C. for 3 hrs. Different ramp-up rates between 0.5° C./min to 3.3° C./min were used during the calcination process of the SnO₂/TiO₂ fibers.

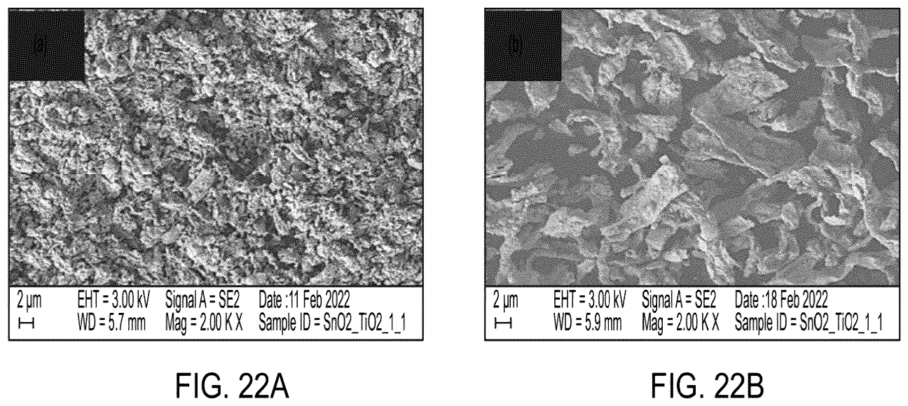

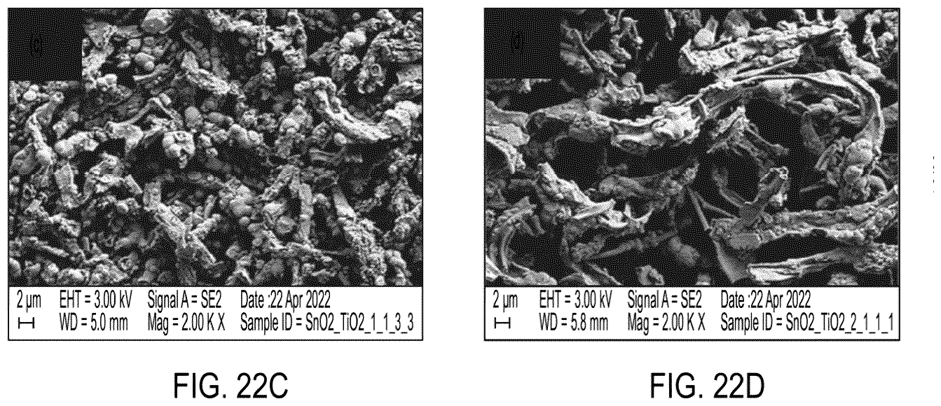

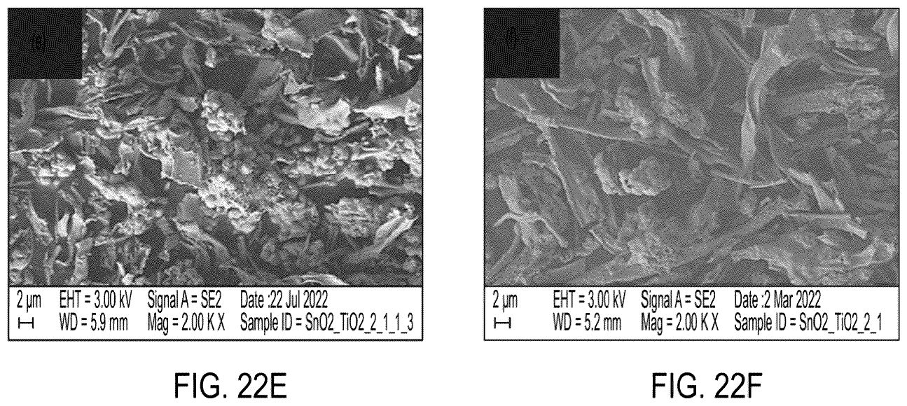

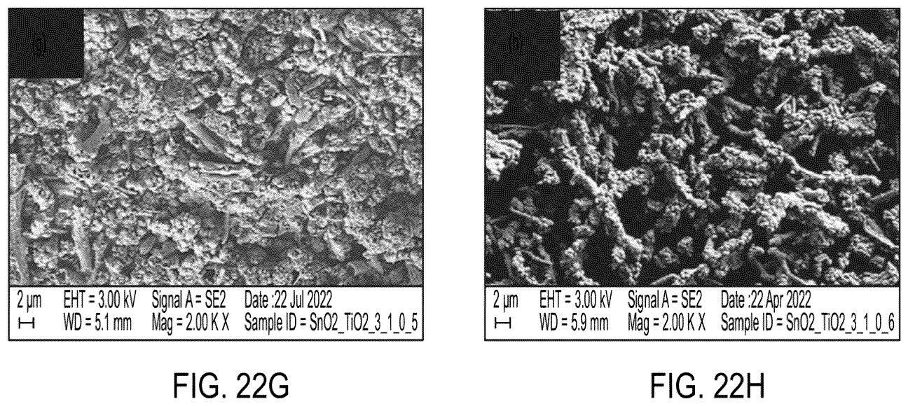

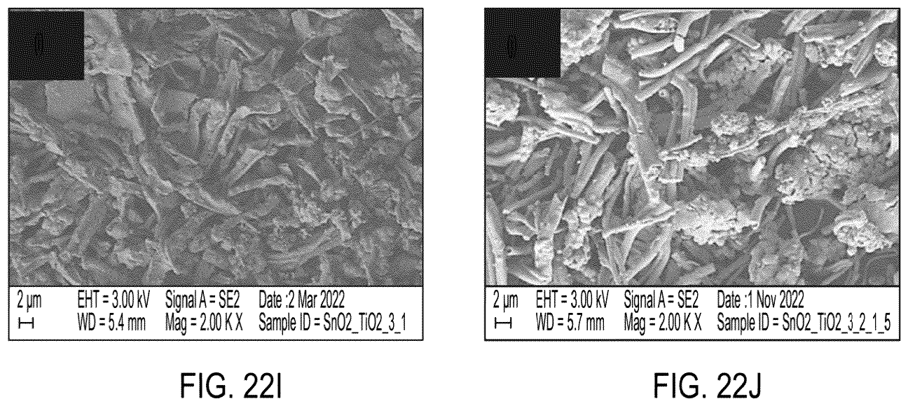

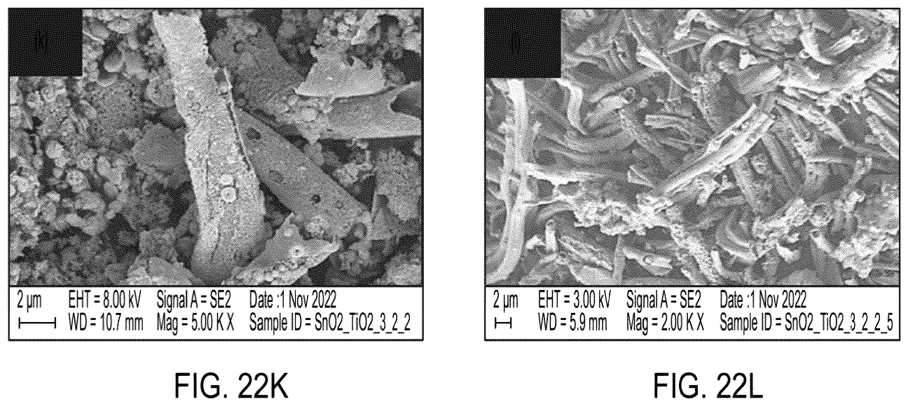

The SnO₂/TiO₂/PVP precursor composite fibers were calcined in a tube furnace using different heating (ramp-up) rates to determine the effect of the heating rate on the micro-belts formation. The rates used for the SnO₂/TiO₂ fibers with (1:1) ratio (FIGS. 22a-c) ranged from 1° C./min to 3.3° C./min. The SEM image in FIG. 22b shows that the SnO₂/TiO₂ micro-belts were formed after the heat treatment at a rate of 3° C./min. The SnO₂/TiO₂ prepared at a rate of 1° C./min (FIG. 22a) showed some micro-belts formation but mostly had random oxidized short fibers. It is worthwhile to note even a low-rate change of 0.3° C./min (i.e., @3.3° C./min) above the previous rate to form micro belts, the ramp-up rate caused the fibers to have a completely different morphology (FIG. 22f). The thermal treatment of the precursor fibers using a ramp-up rate of 3.3° C./min (FIG. 22c) resulted in the formation of short fibers with an abundance of nodules with no definitive shape. The SEM images of SnO₂/TiO₂ fibers with 2:1 ratio (FIGS. 22d-f), prepared at a ramp rate of 1.1° C./min (FIG. 22d) showed the formation of flat fibers with many nodules. The fibers became wider and flatter at a rate of 1.3° C./min (FIG. 22e) with fewer nodules than that at 1.1° C./min. At 1.5° C./min (FIG. 22f), the SEM images showed the formation of micro belts.

The SEM images of SnO₂/TiO₂ fibers with 3:1 ratio (FIGS. 22g-i), prepared at a ramp rate of 0.5° C./min (FIG. 22g) showed short fibers with nodules with no definitive shape. The fibers showed no visual difference at a higher rate of 0.6° C./min (FIG. 22h) than that at 1.1° C./min. At 1° C./min (FIG. 22i), the SEM images showed the formation of micro-belts with the indications of the short fibers becoming smooth.

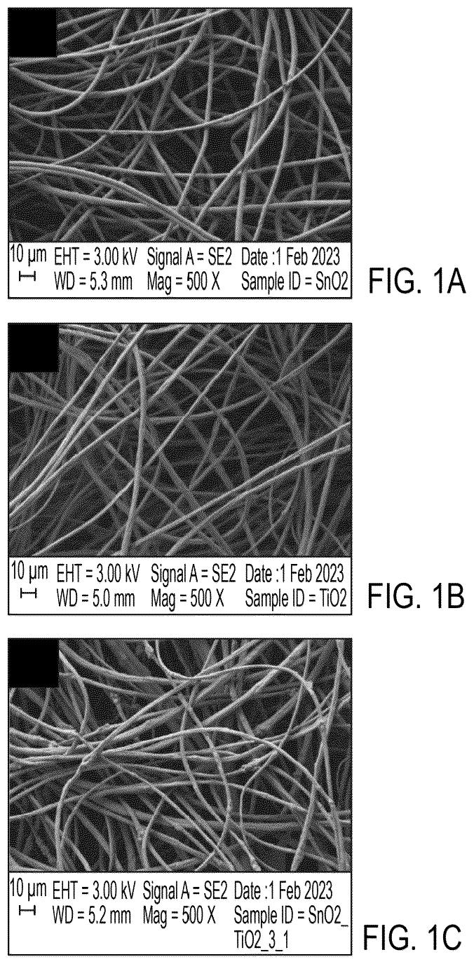

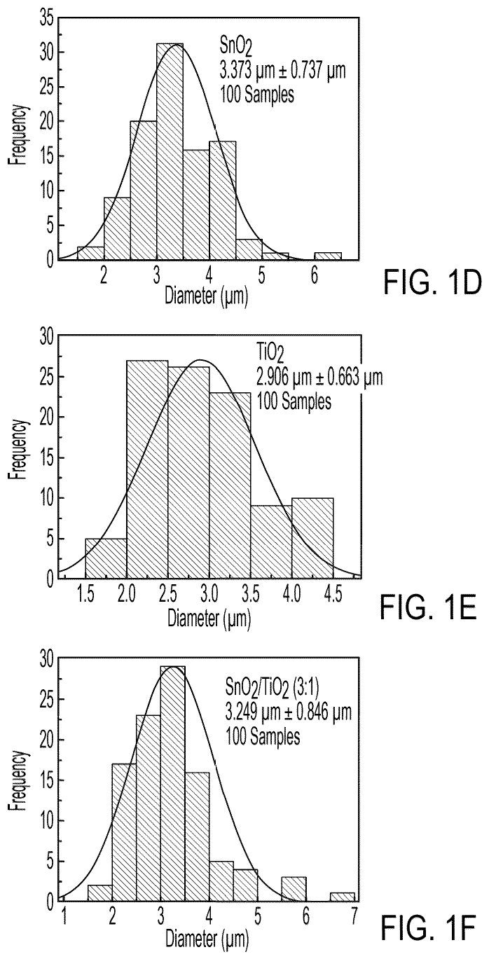

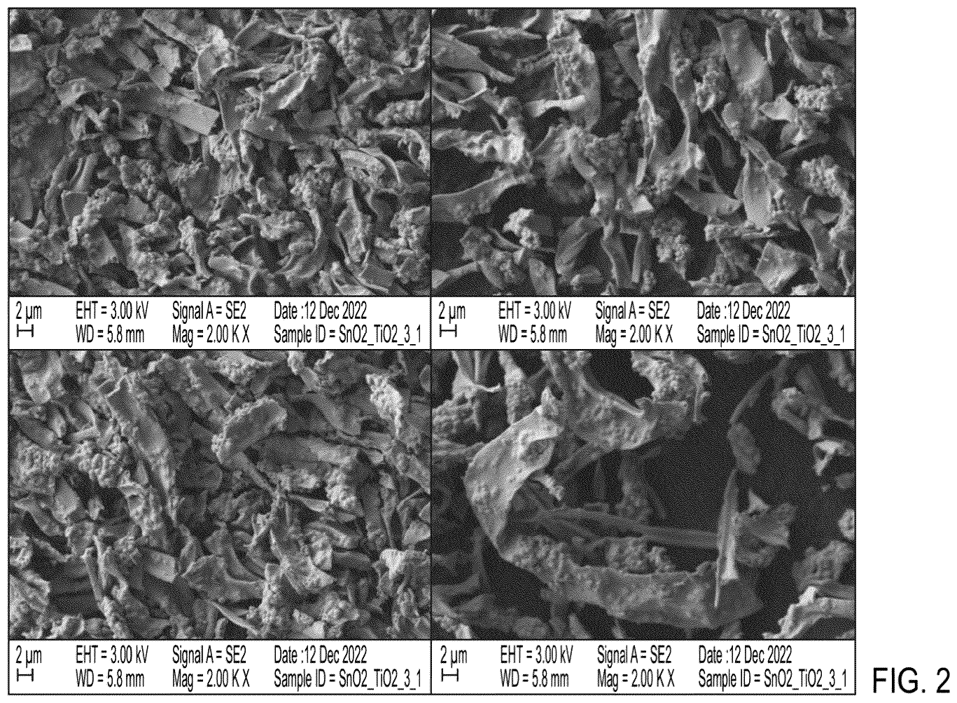

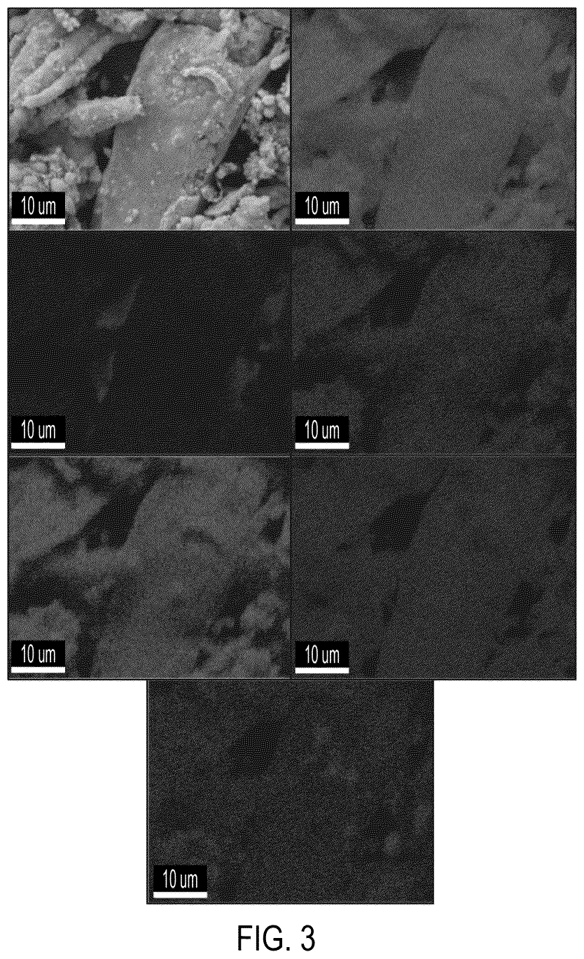

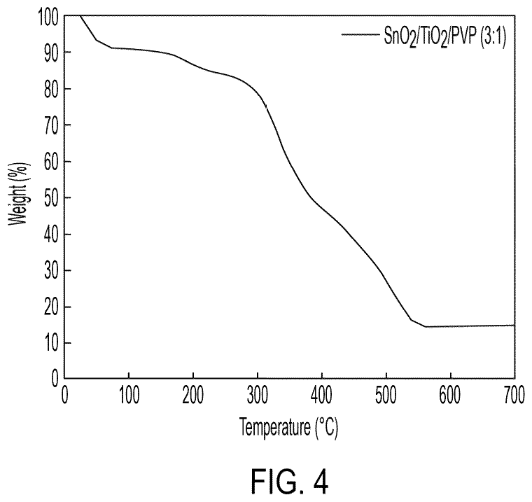

The SEM images of SnO₂/TiO₂ fibers with 3:2 ratio (FIGS. 22j-1) showed micro belts at a rate of 2° C./min (FIG. 22k). FIG. 22j showed that flat belts started to form at a rate of 1.5° C./min, while the 2.5° C./min rate (FIG. 22k) showed a few micro-belts started to blend to form bigger nodules.

The SEM images in FIG. 22 showed a pattern for micro-belts formations: the higher the ratio of SnO₂ in the fibers, the slower the ramp-up rate used during the thermal treatment of the SnO₂/TiO₂ precursor fibers. The minimum (or lowest) SnO₂ concentration in the precursor fibers was 50 wt. % for the 1:1 ratio while the required heating rate for the micro-belts formation was 3° C./min. The maximum (or highest) SnO₂ concentration in the precursor fibers was 75 wt. % for the 3:1 ratio while the required heating rate for the micro-belts formation was 1° C./min. At SnO₂ concentrations of 60 (3:2) and 66 (2:1) wt. %, the heating rates required to form micro belts were 2° C./min and 1.5° C./min, respectively. Alternatively, the pattern can also be described in terms of the TiO₂ concentration in the precursor fibers: the higher the concentration of TiO₂ (25%, 33%, 40%, and 50%), the faster the ramp-up rate needs to be (1° C./min, 1.5° C./min, 2° C./min and 3° C./min).

### CVD Carbon Coatings

The calcined SnO₂/TiO₂ (3:1) short fibers were placed in a quartz boat to be carbon coated in a tube furnace. The material was heated to 1000° C. at a rate of 33° C./min with 160 standard cubic centimeters per min (SCCM) of argon flowing in the chamber. Once the furnace reached 1000° C., 32 SCCM of methane (CH₄) gas filled the furnace so that the carbon coating could take place. Different coating times were implemented to test the effects of CVD on the electrochemical performance of SnO₂/TiO₂: 30 mins and 60 mins. After coating, the furnace cooled down to room temperature, and the material was collected. The white material turned black after the heat treatment, and some of the material fused to form small circular objects. This material was harder than the previous material, and manual grinding was not possible. A Hauschild Speed Mixer (DAC 150.1 FVZ-K) was used at 2300 rpm for 5 min with 2 mm Zirconia ceramic beads to grind the material to a fine powder. Afterward, the carbon-coated material was used to make a slurry on copper foil with the same method as the non-coated material. Anodes were cut out to make half-cell batteries and compare electrochemical performances to the non-carbon coated material.

### Lithium Ion Half-Cell Assembly

The 1/2″ diameter anodes were placed in an argon gas-filled glovebox (MBRAUN) with H₂O and O₂ levels <0.5 ppm. The composite fiber anodes were placed on the top cap of the cell battery, followed by electrolyte, separator, lithium metal (cathode), spacer, spring, and bottom cap. The electrolyte was made from 1M LiPF₆ in EC/DMC (1:1 v/v). A hydraulic crimping machine was used to close the cell battery with 1,000 psi. The assembled batteries were taken out of the glovebox to perform electrochemical testing.

### Structural Characterization

The morphology and elemental composition of the micro-belt fibers were studied using a scanning electron microscope (SEM) (Zeiss Sigma VP) and energy dispersive x-ray spectrometer (EDS) (EDAX). The fibers' thermal degradation was examined by thermalgravimetric analysis (TGA) (TG 209 F3 Tarsus) in air with a 5° C./min heating rate from 27 to 700° C. Similarly, the fibers' crystal structure/crystal phase were studied using X-ray photoelectron spectroscopy (XPS), x-ray diffraction spectroscopy (XRD), and Raman spectroscopy analyses. Carbon coating thickness, crystal structure and uniformity on the nanofiber surface were analyzed using JEOL JEM-1230 Transmission Electron Microscope after dissolving the nanofibers in solvent and drop casting on carbon-coated Cu TEM grid.

Raman Spectroscopy was carried out on the CVD coated samples. The carbon coating on the SnO₂/TiO₂ short fibers have distinct peaks at ˜1360 cm⁻¹ (D band) and 1580 cm⁻¹ (G band) along with a 2D band ˜2750 cm⁻¹. The abovementioned peaks depict the pyrolytic carbon (Similar to graphite, where graphene layers are stacked in parallel, pyrolytic carbon additionally includes translation and/or rotation about the graphene plane) coating on the short nanofibers. G bands corresponds to the in-plane stretching of graphite, and the D band represents the defect-induced double resonant scattering. The weak second order 2D bands refers to the three-dimensional ordering (in c-direction) of pyrolytic carbon. Ratio of G/D band of greater than 1 indicates better graphitization degree and more stable carbon coating.

Transmission electron microscopy images at different magnifications were also taken to further study the structure and morphology of the SnO₂/TiO₂ coated fibers. The TEM images (not shown) shows the pyrolytic carbon coating dimension of ˜9.25 nm on the short nanofibers. By analyzing different images, the coating dimension at different spatial locations was in the range 6-10 nm. Also, the coating enables a much more stable layer which protects the short, composite fibers. The amorphous pyrolytic carbon coating can also be verified from the distinct d-spacing (3.2 Å). The Selected area electron diffraction (SAED) showed the polycrystallinity of the pyrolytic carbon as concentric circles with different diameters. Therefore, the CVD pyrolytic carbon coating acted as a protective surface which improves the cycle performance of the anodes.

### Comparative Example 1—Non-Coated Electrode Materials

SEM images were taken to study and examine the surface morphology and structure of the pristine and oxidized composite fibers. From FIG. 1, with a 500× magnification and a scale of 10 μm, the pristine fibers can be seen to have a cylindrical structure. The diameters were calculated by measuring 100 fibers from each sample and taking their average. According to the calculations, the PVP/SnO₂ fibers have the biggest diameter with a mean size of 3.373±0.737 μm, followed closely by the composite sample with a mean diameter of 3.249±0.846 μm. Subsequently, the TiO₂/PVP fibers had the smallest fibers with a mean diameter of 2.906±0.663 μm. Overall, the centrifugally spun fibers for all samples showed cylindrical structures with average diameters between 2.906 and 3.373 μm.

### Electrochemical Performance

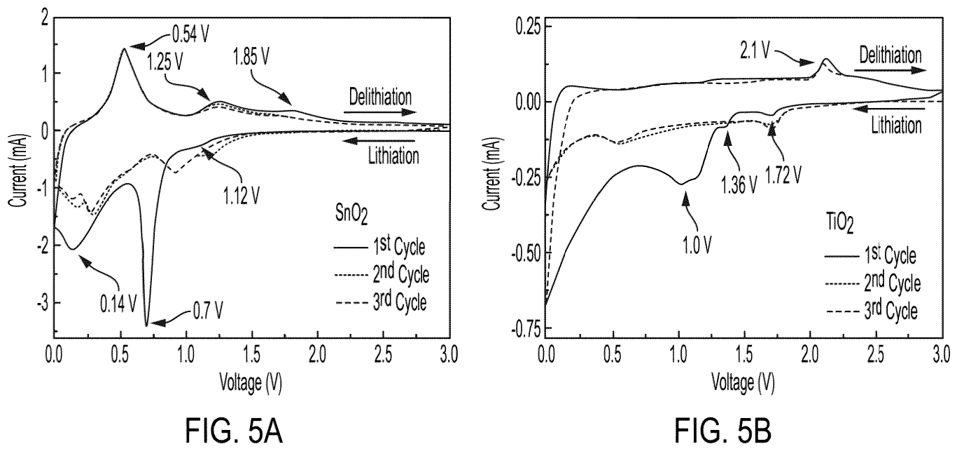

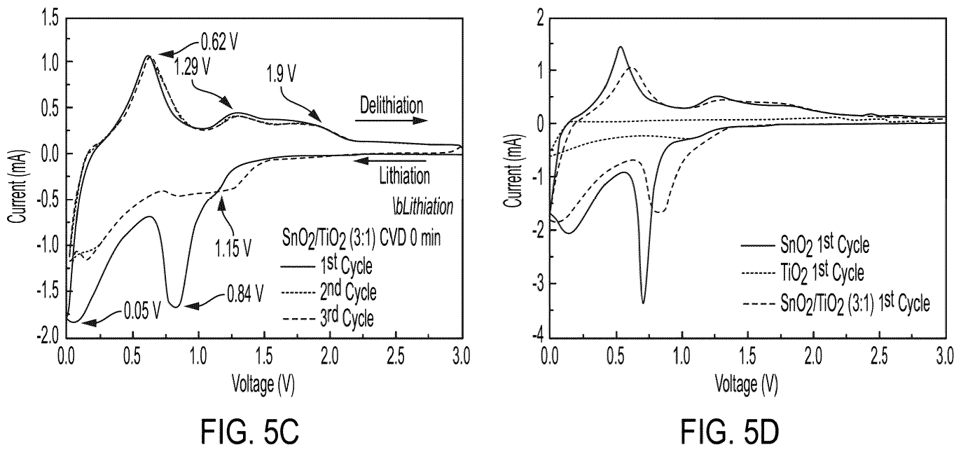

The lithiation/de-lithiation reactions of the SnO₂/TiO₂ composite-fiber anodes were studied using cyclic voltammetry (CV) tests. The CV experiments were performed for four cycles using a voltage window of 0.01-3 V at a scan rate of 0.1 mV s⁻¹. FIG. 5 shows the CV scans the first three cycles for (a) SnO₂, (b) TiO₂, and (c) SnO₂/TiO₂ (3:1), as well as (d) the first cycles of all three samples together. All three samples (a-c) show a difference between the first cycle (black line) and the second cycle (red line), indicating the formation of the solid electrolyte interface (SEI) layer on the surface of the electrode. Afterward, the second and third cycles (red and blue lines) overlap, indicating good reversibility and high Coulombic efficiency.

In FIG. 5a, the SnO₂ fibers shows two main reduction peaks occurring during the first cycle at 0.7 and 0.14 V, which are due to the irreversible formation of the Li₂O-SEI layer and the reduction of SnO₂ to Sn (eq. 1) and the alloying formation of LiₓSn (eq. 2 where x=4.4), respectively. Conversely, the SnO₂ sample shows three oxidation peaks occurring at 0.54, 1.25, and 1.85 V due to the dealloying of LiₓSn, the re-oxidation of Sn to SnO, and the continued re-oxidation of SnO to SnO₂ (eq. 3). The CV results closely match Zhao et al.'s SnO₂/Sn sample results with reported initial cathodic peaks of 0.71 and 0.08 V and anodic peaks of 0.60, 1.29, and 1.82 V. Furthermore, the cathodic peaks after the first cycle shift to a higher voltage (a shift to the right) and indicate the alloying process of LiₓSn (eq. 2).

The process of the SnO₂ reduction/oxidation can be written out in the following equations:

$${SnO}_{2} + 4 {Li}^{+} + 4 {e}^{-} \to Sn + 2 {Li}_{2} O \qquad ( 1 )$$

$$Sn + {x Li}^{+} {xe}^{-} ↔ {Li}_{x} Sn ( 0 \leq x \leq 4.4 ) \qquad ( 2 )$$

$${SnO}_{2} + {x Li}^{+} + {xe}^{-} ↔ {Li}_{x} {SnO}_{2} \qquad ( 3 )$$

FIG. 5b shows the first three cycles of TiO₂ fiber-anode. The CV scans shows one main reduction peak at 1.0V, which does not correspond to any subsequent cycles indicating the formation of the SEI layer. Additionally, the oxidation process shows a peak at 2.1 V which is attributed to the de-lithiation of LiₓTiO₂ (eq. 4). The anodic peaks overlap with the second and third cycles indicating good reversibility. The following equation can express the reversible lithium insertion/extraction process:

$${TiO}_{2} + {x Li}^{+} + {xe}^{-} ↔ {Li}_{x} {TiO}_{2} \qquad ( 4 )$$

FIG. 5c shows the first three cycles of the SnO₂/TiO₂ composite fibers with (3:1) ratio.

The CV shows a similarity between the composite sample and the pristine SnO₂ fibers The cathodic peaks of the composite sample are located at 0.84 and 0.05 V (compared to the peaks of SnO₂ at 0.7 and 0.14 V), which result from the formation of the SEI layer and reduction of SnO₂ to Sn and the alloying of Sn and Li. Similarly, the anodic peaks of the composite sample are 0.62, 1.29, and 1.9 V (compared to SnO₂ peaks at 0.54, 1.25, and 1.85 V), which are the results of the dealloying of Sn and Li and the reoxidation of SnO₂. The subsequent cycles show curves that overlap, indicating good reversibility. The close similarities between the SnO₂ and the SnO₂/TiO₂ composite fibers could be due to the low conductivity of the TiO₂ (current range from −0.66-0.12 mA) compared to SnO₂ (current range from −3.41-1.42 mA), causing the reaction voltage to minimally shift the voltage to the right and minimally reduce the current at which the reactions happen. The scale of this occurrence can be noticed visually in FIG. 5d, where the first cycles of each sample are shown together; the peaks of the SnO₂ sample (black line) are the biggest, followed by the 3:1 composite sample (blue line) and lastly by the TiO₂ sample (red line).

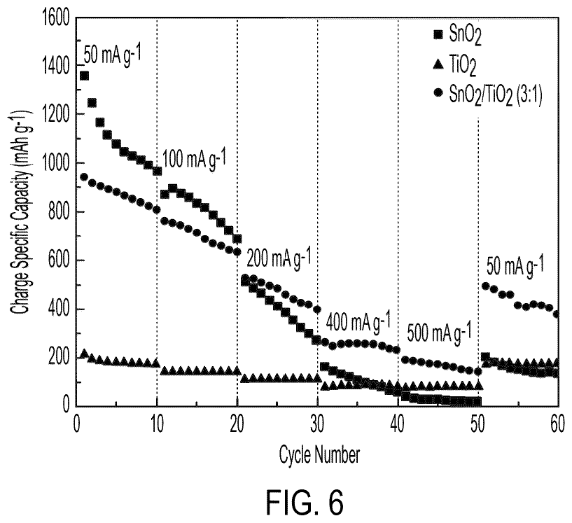

Apart from cycle performance, rate performance tests were also performed. The experiments were conducted to analyze the battery's performance under different current densities (50, 100, 200, 400, 500, and 50 mA g⁻¹) compared to the cycle performance test at a constant current density of 100 mA g⁻¹. The rate performance experiment at each current density is performed for 10 cycles for a total of 60 cycles. FIG. 6 shows the rate performance results of SnO₂, TiO₂, and SnO₂/TiO₂ (3:1) fibers. The data reinforces the cycle performance data in which SnO₂ starts with a high charge specific capacity (1358 mAh g⁻¹) followed by a steep decline to 965 mAh g⁻¹ (28.9% loss) at the end of the current density cycle due to the pulverization of the anode. As the current density ramps up, the charge specific capacity falls. At 500 mA g⁻¹ the charge specific of SnO₂ falls below TiO₂ to 37 mAh g⁻¹ (97.3% loss) before increasing to 204 mAh g⁻¹ and finishing with 135 mAh g⁻¹ at 50 mA g⁻¹. This results in a capacity retention (between initial and final current density of 50 mA g⁻¹) of 9.94%. Similar to the cycle performance, TiO₂ starts at a low charge specific capacity (214 mAh g⁻¹) and maintains a consistent charge specific capacity throughout the current densities. In fact, the TiO₂ sample gains capacity at 200, 400, 500 and 50 mA g⁻¹ with gains of 5.60, 10.3, 11.1, and 1.72%, respectively. At the final current density, the TiO₂ fiber-anode ends with an impressive capacity retention of 82.7%. Furthermore, the SnO₂/TiO₂ composite fibers with 3:1 ratio followed the same trend as the SnO₂ fibers with a high initial charge specific capacity of 940 mAh g⁻¹ followed by a decline to 808 mAh g⁻¹ (14% loss) due to the pulverization of the anode. At 500 mA g⁻¹ the charge specific capacity falls to 190 mAh g⁻¹ (79.8% loss) and rises to 494 mAh g⁻¹ at 50 mA g⁻¹. The 3:1 sample finish with a capacity retention of 40.3%.

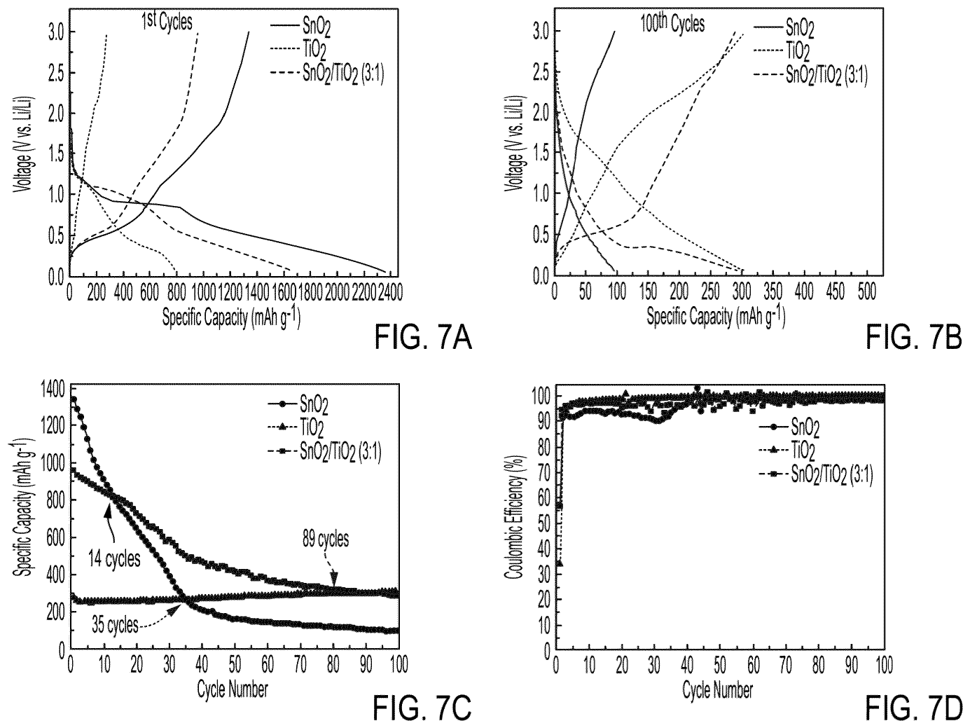

FIG. 7 shows the cycle performance and the Coulombic efficiency of SnO₂, TiO₂, and SnO₂/TiO₂ for the first 100 cycles. FIG. 7a shows the initial charge/discharge performance curves of SnO₂ (black line), TiO₂ (blue line), and SnO₂/TiO₂ (3:1) (red line). The parent samples show a vast difference in the irreversible discharge specific capacity from 2,365 mAh g⁻¹ for SnO₂ to 815 mAh g⁻¹ for TiO₂. After the first discharge, the SEI layer has formed on the surface of the electrode, causing the capacity to drop to 1,337 mAh g⁻¹ for SnO₂ and 277 mAh g⁻¹ for TiO₂, a capacity loss of 43.5% and 66%, respectively. However, due to the volume expansion of charging/discharging experienced throughout the life cycle (FIG. 7c), the SnO₂ anode is pulverized, resulting in a charge-specific capacity of 95 mAh g⁻¹ and a capacity retention (from first charge to last charge) of 7%. On the other hand, TiO₂ can withstand the volume expansion resulting in a charge-specific capacity of 307 mAh g⁻¹ and a capacity retention of 111%. With these results, the composite sample of 3:1 was synthesized to obtain a sample that can take advantage of the high capacity of SnO₂ while minimizing the vast volume expansion with TiO₂. The first cycle for the 3:1 sample showed an initial specific capacity of 1,677 mAh g⁻¹ and a subsequent charge-specific capacity of 956 mAh g⁻¹ (43% capacity loss similar to the SnO₂ sample). After 100 cycles, the charge-specific capacity dropped to 289 mAh g⁻¹ resulting in a capacity retention of 30.2%, significantly better than the 7% retention of SnO₂ but considerably worse than the 111% retention of TiO₂. To further compare the life cycles of each sample, the charge-specific capacities of each sample for every cycle are plotted and shown in FIG. 7c. The figure shows an immediate steep slope for SnO₂ dropping past the 3:1 sample at 14 cycles with a charge-specific capacity of 795 mAh g⁻¹ (40.5% capacity loss). The SnO₂ capacity continues to decline, passing the TiO₂ sample at 35 cycles with a specific capacity of 267 mAh g⁻¹ (80% capacity loss). Meanwhile, the SnO₂/TiO₂ composite fibers with 3:1 ratio declines with a flatter slope than SnO₂, demonstrating the advantage of adding the ductile TiO₂ to the sample. Furthermore, the composite sample retains a higher capacity than TiO₂ until the 89^{th} cycle with a specific capacity of 299 mAh g⁻¹ (68.7% capacity loss). The final cycle shows that the composite sample finishes with a specific capacity close to that of the TiO₂ parent sample while having a higher capacity throughout the majority of its 100 cycles.

Additionally, FIG. 7d shows the Coulombic efficiency of all samples. Each sample shows an efficiency >90% after the first cycle, with the TiO₂ fiber-anode being the most consistent throughout its life cycle. The SnO₂ fibers begin with a low efficiency of around 90% and increases to >98% after 44 cycles. The SnO₂/TiO₂ composite fiber-anode with 3:1 ratio starts with a high efficiency of ˜96% but becomes inconsistent after 24 cycles ranging from 93% to 101%.

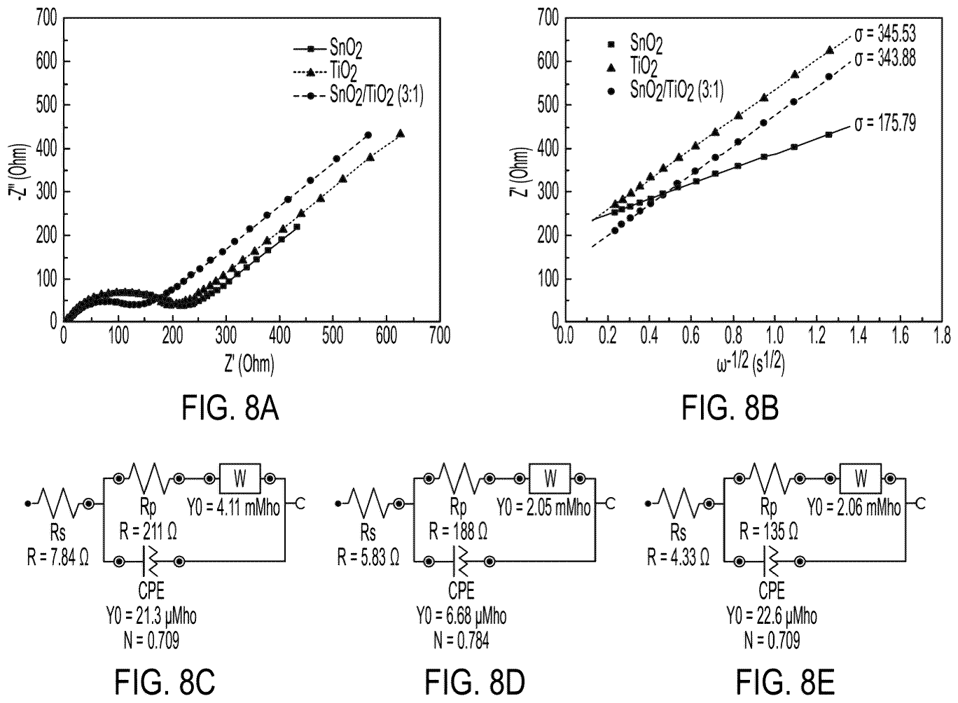

Electrochemical impedance spectroscopy (EIS) tests were used to study the battery's electrochemical kinetics. The tests were performed from 0.1 to 100,000 Hz and plotted with the imaginary axis of −Z″ (Ohm) vs. the real axis of Z′ (Ohm). FIG. 8a shows the Nyquist plots for the different samples. Nyquist plots are used to explain the battery's impedance visually and are shown as a depressed semi-circle (medium-high frequency range) with a sloping tail (low-frequency range). In general, Li-ion batteries behave like an electrical circuit comparable to a resistor (Rₛ) in series with a resistor (Rₚ) and a Warburg impedance (W) that are in parallel with a double-layer capacitance (CPE), as shown in FIGS. 8c-e. Rₛ, is the solution's (electrolyte) resistance. Its value is associated with the distance between the origin and the first x-value before the semi-circle begins. Rₚ, also known as R_{ct}, is representative of the entire depressed semi-circle and is the polarization resistance (charge transfer resistance) within the interface between the electrolyte solution and the electrodes. The CPE variable is the constant phase element, with the Y₀ variable representing the resistance in Mho and the “N” variable representing a constant ranging between 0 and 1; if N=1, then the CPE acts as an ideal capacitor, and if N=0 then the CPE acts as a pure resistor. In the low-frequency range, the sloping tail corresponds with the Warburg resistance that describes the diffusion of Li⁺ in the electrode and is represented by the variable Y₀. Additionally, the Warburg resistance can be used to find the Warburg factor, σ, by calculating the slope of the real resistance (Z′) vs. angular velocity (ω^{-1/2}) plot in FIG. 8(b).

According to the results in Table 1, the SnO₂ sample has the lowest Warburg factor indicating higher diffusivity of Li⁺. The solution resistance for all samples is similar, with a small range between 4.33 and 7.84Ω (3:1 and SnO₂, respectively). The polarization resistance of the samples shows that the composite model has the lowest resistance with a value of 135Ω, which is graphically represented in FIG. 8a by having a smaller semi-circle diameter. The low charge transfer resistance could be explained by the synergetic effect of the SnO₂ and the TiO₂ material.

TABLE 1
Nyquist Data for Equivalent Circuits
of SnO₂, TiO₂, and SnO₂/TiO₂ (3:1)

| | Rs | Rp | CPE | | W | σ (Ω |
|---|---|---|---|---|---|---|
| Sample | (Ω) | (Ω) | Y₀ (μMho) | N | Y₀ (mMho) | s^{-0.5}) |
| SnO₂ | 7.84 | 211 | 21.3 | 0.709 | 4.11 | 175.79 |
| TiO₂ | 5.83 | 188 | 6.68 | 0.784 | 2.05 | 345.53 |
| SnO₂/TiO₂ | 4.33 | 135 | 22.6 | 0.709 | 2.06 | 343.88 |
| (3:1) | | | | | | |

### Example 1—Carbon Coated Electrode Materials

The structure and morphology of the SnO₂/TiO₂ (3:1) CVD 30- and 60-min active materials were characterized by SEM, EDS, TGA, XPS, and XRD. The coated active materials were sprayed with gold particles using sputtering method to collect clearer images from SEM and EDS. They were also placed in the TGA and heated to 800° C. under an argon atmosphere and continued to 1000° C. in air at a rate of 5° C./min to examine the thermal degradation.

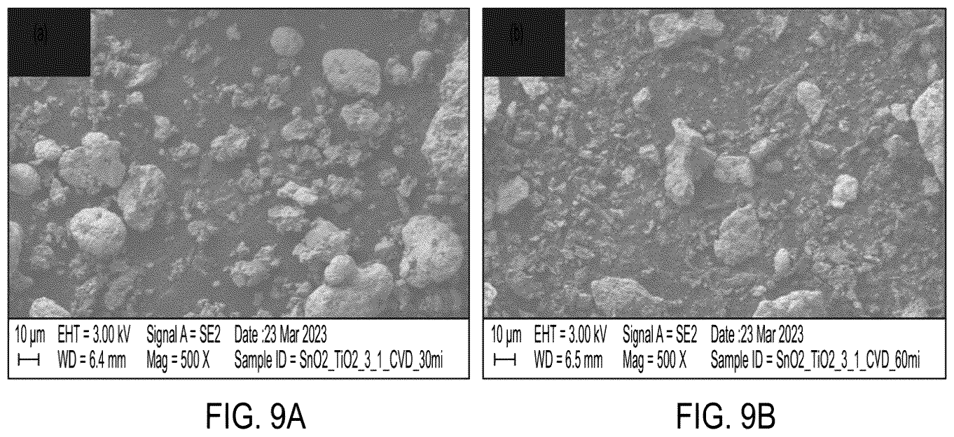

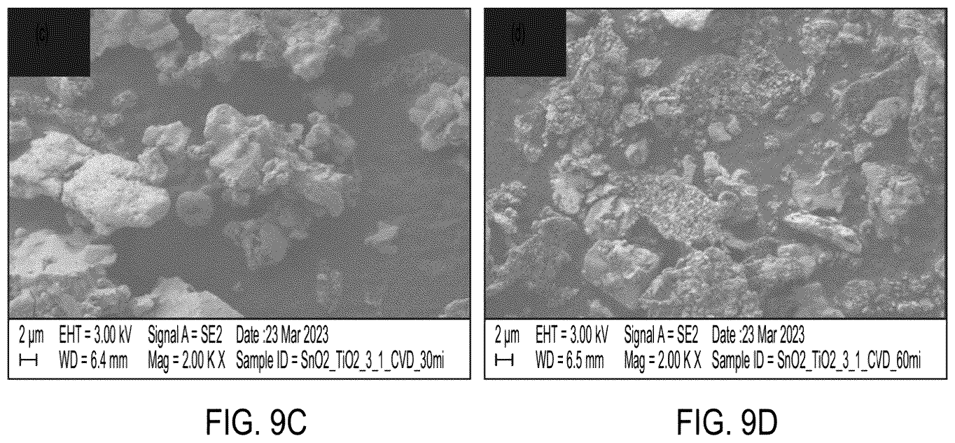

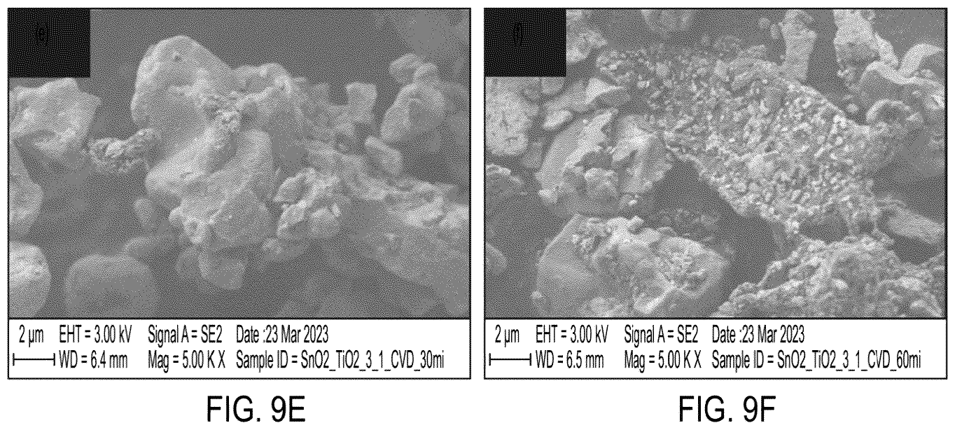

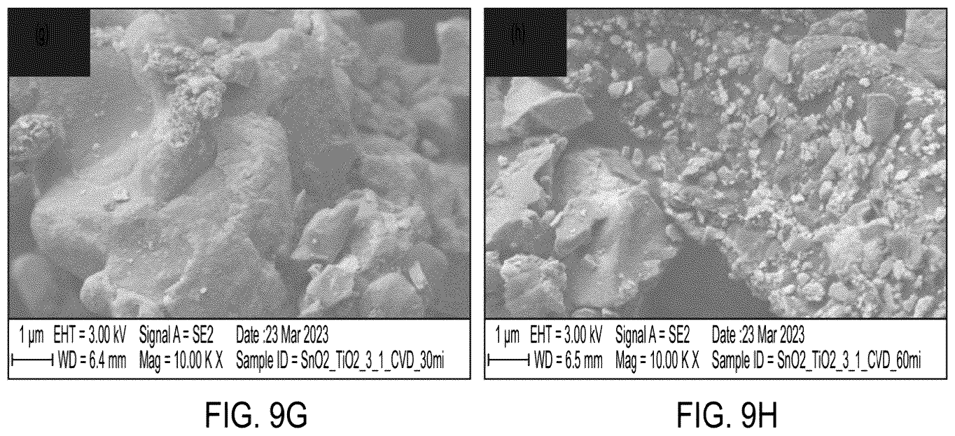

The morphology and structure of the SnO₂/TiO₂ (3:1) CVD 30- and 60-min active materials were analyzed by SEM using 500x, 2000x, 5000x, and 10000× magnification. FIGS. 9a-h shows the SEM images. Both the 30- and 60-min images show big rock-like structures ranging from 2 to 10 μm. Upon closer inspection some micro-belt structures were found scattered across the sample area. After the deposition of carbon-coating at 1000° C., some of the material fused together to form large rock-like structures from the small particles placed in the furnace. To prevent a poor thin-film application onto the copper foil, the carbon-coated material was placed in a grinder and mixer to grind the material into smaller particles.

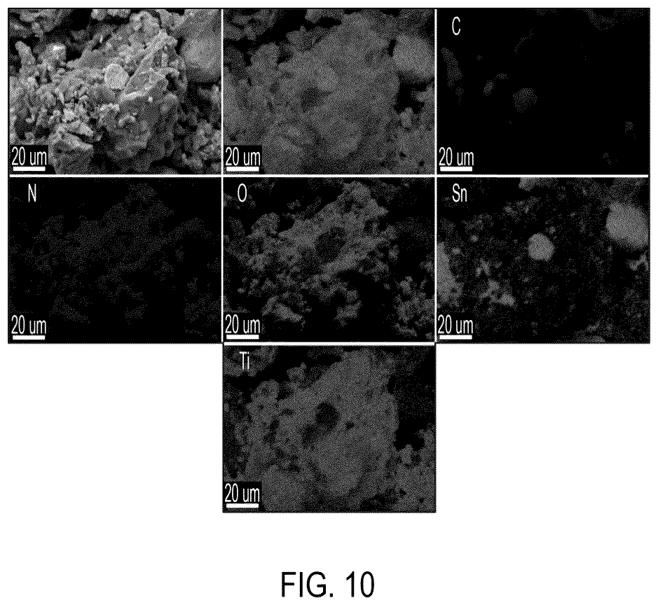

FIG. 10 shows the EDS mapping of the SnO₂/TiO₂ (3:1) CVD 30-min sample. The mapping shows the material consists of the same elements as the pristine fibers and calcined micro-belt fibers: carbon (C), nitrogen (N), oxygen (O), tin (Sn), and titanium (Ti). However, the amount of Sn and Ti are completely different. For the SnO₂/TiO₂ (3:1) pristine fibers the weight % for Sn was 13.91% and 2.97% for Ti. For the SnO₂/TiO₂ (3:1) calcined fibers the weight % was 75.38% and 8.49%. In each mapping report the ratio stayed within the 3:1 ratio (65.3%:35.7% and 78.2%: 21.8%, respectively), but in the CVD 30-min report, Table 2, the ratio is Ti-heavy with a ratio of 19.7%:80.3%. FIG. 10 also shows that the elements are clustered together as opposed to being well-mixed like the calcined micro-belt fibers. The overlay image in FIG. 10 shows Sn (yellow) concentrated to the white rock-like structures, while the Ti (cyan) is concentrated to the bigger gray rock-like structures. Oxygen and nitrogen are spread across the entire area, while the carbon is concentrated to black pieces that seem to be broken up from smaller pieces similar to FIG. 9h.

TABLE 2
EDS Mapping Results of SnO₂/TiO₂ (3:1) CVD 30-min

| Element | Weight % | Atomic % | Net Int. | Error % | Kratio | Z | A | F |
|---|---|---|---|---|---|---|---|---|
| C K | 4.82 | 13.28 | 109.20 | 6.12 | 0.0370 | 1.3168 | 0.5823 | 1.0000 |
| N K | 1.57 | 3.71 | 31.10 | 7.15 | 0.0124 | 1.2839 | 0.6118 | 1.0000 |
| O K | 21.51 | 44.47 | 296.50 | 9.59 | 0.0600 | 1.2551 | 0.2223 | 1.0000 |
| SnL | 27.30 | 7.61 | 303.20 | 3.11 | 0.2232 | 0.7726 | 1.0475 | 1.0104 |
| TiK | 44.80 | 30.93 | 673.10 | 3.09 | 0.4142 | 0.9641 | 0.9562 | 1.0029 |

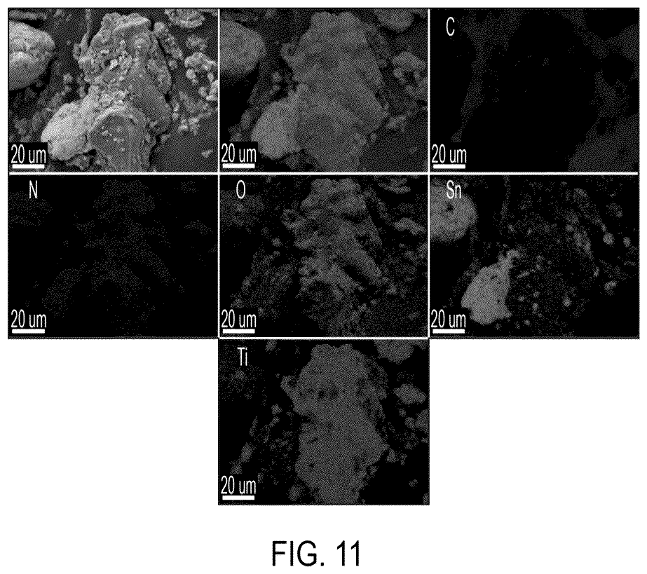

FIG. 11 shows the EDS mapping of the SnO₂/TiO₂ (3:1) CVD 60-min sample. The figure shows the same pattern as FIG. 10: Ti-heavy structures, clustering of elements, white rock-like structures of Sn, oxygen and nitrogen throughout the area, and carbon in black broken up pieces. Table 3 shows the SnO₂/TiO₂ (3:1) CVD 60-min sample to have a ratio of 24.5%:75.5% (0.98:3.02). It is worthwhile to note that the ratios from FIGS. 10 and 11 pertain to their specific areas only, but other areas not included in these images showed the same trend. Additionally, EDS mapping does an elemental composition of the surface of the selected areas and will be compared to the elemental compositions found in the XPS characterization.

TABLE 3
EDS Mapping Results for SnO₂/TiO₂ (3:1) CVD 60-min

| Element | Weight % | Atomic % | Net Int. | Error % | Kratio | Z | A | F |
|---|---|---|---|---|---|---|---|---|
| C K | 19.16 | 39.61 | 480.50 | 5.19 | 0.1536 | 1.2411 | 0.6460 | 1.0000 |
| N K | 5.21 | 9.24 | 68.30 | 8.32 | 0.0256 | 1.2097 | 0.4063 | 1.0000 |
| O K | 19.08 | 29.62 | 277.70 | 9.55 | 0.0531 | 1.1822 | 0.2354 | 1.0000 |
| SnL | 25.20 | 5.27 | 279.30 | 3.30 | 0.1944 | 0.7252 | 1.0542 | 1.0088 |
| TiK | 31.35 | 16.26 | 471.20 | 3.14 | 0.2742 | 0.9040 | 0.9636 | 1.0040 |

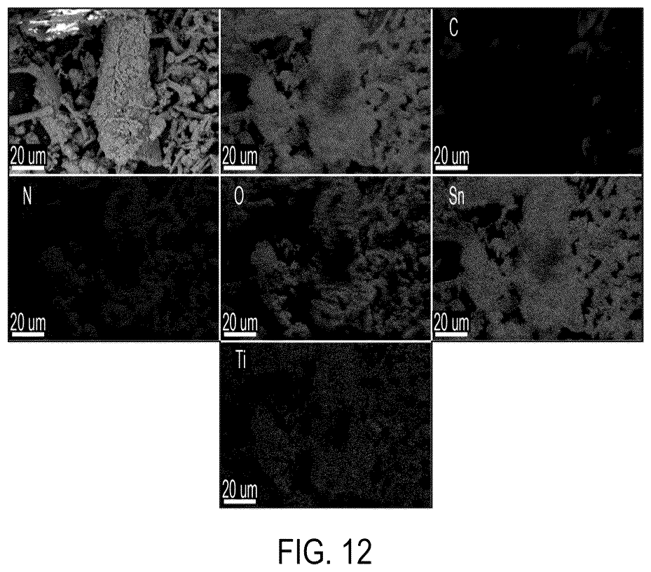

To verify the results of the separation of elements in FIGS. 10 and 11, a sample of SnO₂/TiO₂ (3:1) was heat treated to 1000° C. under argon without methane for the same amount of time as the CVD sample (30-min). FIG. 12 shows the elemental mapping of the heat-treated sample without methane gas. It shows no element separation and keeps the ratio of 77.2%:22.8% (3.1:0.9) as shown in table 4. These results conclude that the high temperature alone was not the cause of the element separation and that the cause could be the methane gas used to carbon-coat the sample.

TABLE 4
EDS Mapping Results for SnO₂/TiO₂ (3:1) Heat Treated at 1000° C. Under Argon

| Element | Weight % | Atomic % | Net Int. | Error % | Kratio | Z | A | F |
|---|---|---|---|---|---|---|---|---|
| C K | 4.43 | 19.12 | 94.70 | 4.94 | 0.0512 | 1.5418 | 0.7499 | 1.0000 |
| N K | 2.25 | 8.34 | 34.80 | 6.23 | 0.0240 | 1.4999 | 0.7100 | 1.0000 |
| O K | 9.28 | 30.06 | 171.90 | 7.71 | 0.0638 | 1.4638 | 0.4700 | 1.0000 |
| SnL | 75.09 | 32.79 | 324.30 | 3.77 | 0.6672 | 0.8756 | 1.0138 | 1.0011 |
| TiK | 8.95 | 9.68 | 42.90 | 7.20 | 0.0945 | 1.1391 | 0.9234 | 1.0037 |

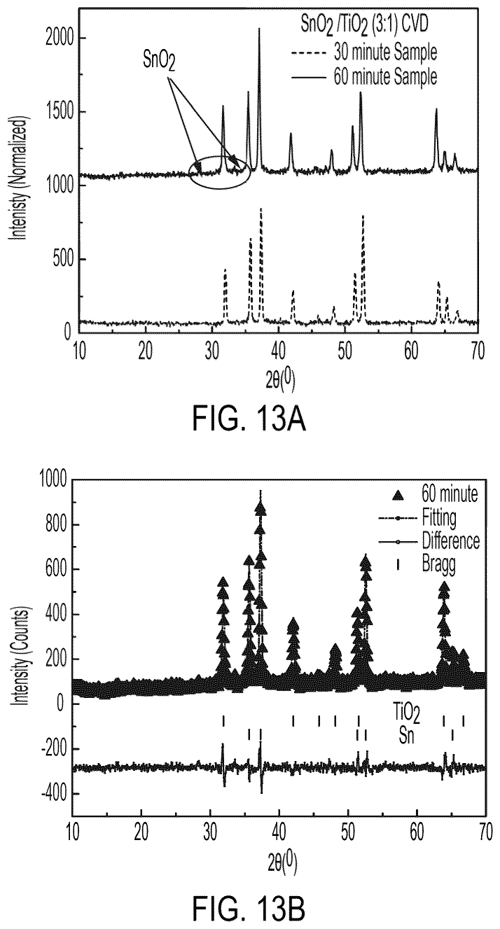

FIG. 13 shows the XRD analysis for both the 30- (FIG. 13a) and 60-minute (FIG. 13b) samples, which appear to be very similar with respect to the major phases present. The LeBail fitting of the samples show 2 major phases present which were TiO₂ in the rutile phase and Sn as metallic tin. The reduction of the Sn from the SnO₂ may have occurred through the presence of hydrogen gas or during the carbonization process, which has been shown in the literature. The results of the LeBail fitting are shown in Table 5, which show a good agreement between the literature and fitting for the presence of both phases in the 60-minute. Due to the similarity between the phases present in the samples only one sample was fitted in FIG. 13b. The reduced χ² of the fitting was 2.62 which shows a great agreement between the literature and the current data. The TiO₂ present in the sample was determined to be in the rutile phase, and the Sn present in the sample was in the metallic form β-Tin.

TABLE 5
LeBail Fitting of the SnO₂/TiO₂ (3:1) CVD 30- and 60-min.

| Phase | Space Group | a | b | c | α(°) | β(°) | γ(°) | χ² |
|---|---|---|---|---|---|---|---|---|
| TiO₂ | P4₂/mnm | 4.603 | 4.603 | 2.969 | 90.0 | 90.0 | 90.0 | 2.62 |
| SnO₂ | I4₁/amd | 5.847 | 5.847 | 3.187 | 90.0 | 90.0 | 90.0 | |

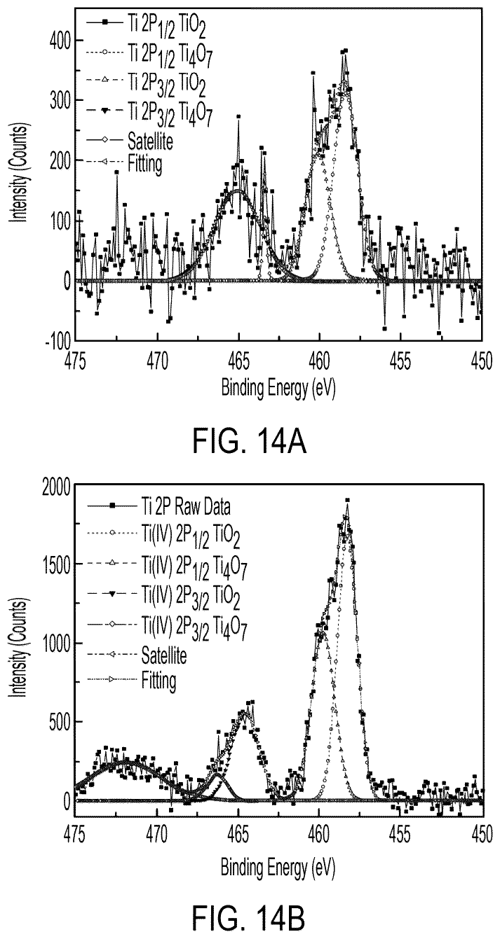

FIG. 14 shows both the Ti 2P XPS spectra for the 30- (FIG. 14a) and 60-minute (FIG. 14b) samples. The samples consisted of 3 peaks, centered at 458.3, 464.5, and 471.9 eV which represent the Ti 2P_{1/2}, Ti 2P_{3/2}, and the Ti 2P satellite, respectively. For the 30-min sample, the intensity was not high enough to determine the surface chemistry of the sample with any degree of certainty. However, the 60-min sample showed ample signal for determination of the chemistry of the 458.4 and 459.7 eV. The peak centered at 458.4 eV is consistent with TiO₂. However, the peak centered at 459.7 eV is consistent with samples that have been annealed at 450° C. in hydrogen gas. The energy shift has been attributed to the loss of oxygen from the sample surface. The Ti 2P_{3/2} peak was deconvolved into two individual peaks as well, which were centered at 464.4 and 466.1 eV. The peak centered at 464.4 eV is representative of TiO₂ in the rutile phase. The presence of the peak at 466.1 eV is representative of the process described of the Ti 2P.

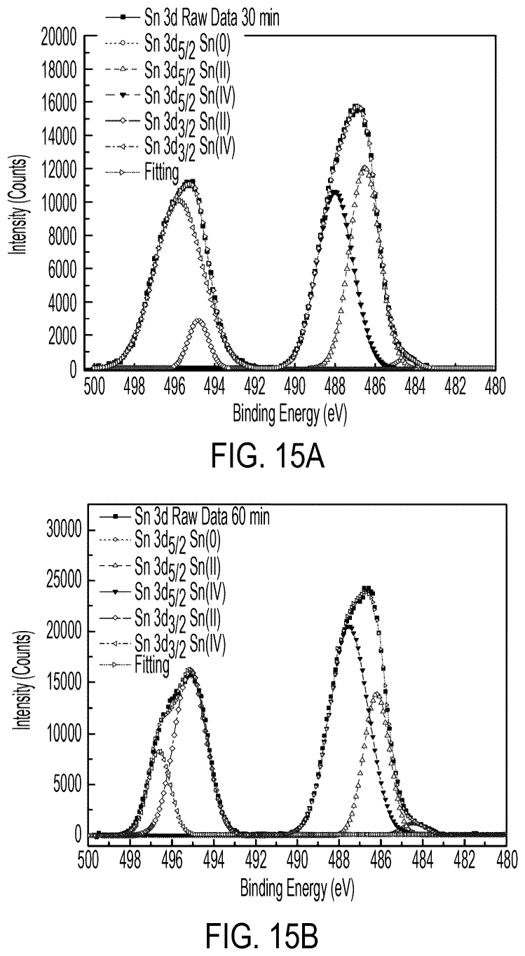

FIG. 15 shows the Sn 3d XPS spectrum which consisted of 2 peaks located at 486.7 and 495.08 eV for both the 30- (FIG. 15a) and 60-minute (FIG. 15b) samples. The peak at 486.7 eV represents the Sn3d_{5/2} was further deconvolved into 3 component peaks, located at 484.8, 486.3, and 487.5 eV. The 3 component peaks represent the Sn in the Sn(0) metal, Sn(II)—O, and the Sn(IV)—O₂ binding environments. Whereas the peak centered at 495.08 eV represents the Sn3d_{3/2} spectra, which was deconvolved into 2 peaks, centered at 495.0 and 496.6 eV, which are representative of the Sn3d_{3/2} binding environments for Sn(II)—O and the Sn(IV)-O₂. The Sn(0) peak was not observed due to the low intensity of the peak in the spectra. The Sn3d XPS data does appear to be contradictory to the XRD data, which showed a major phase of Sn metal and a minor oxide phase. The minor oxide phase was only observed in the 60-min samples. There is no contradiction between the data, the XPS sample of Sn(0) metal with thin oxide films show larger amounts of oxide compared to the amount of metal present. This has to do with the X-ray passing through an oxide film before hitting the reduced metal, which give the appearance of a large amount of oxide and small amount of metal present.

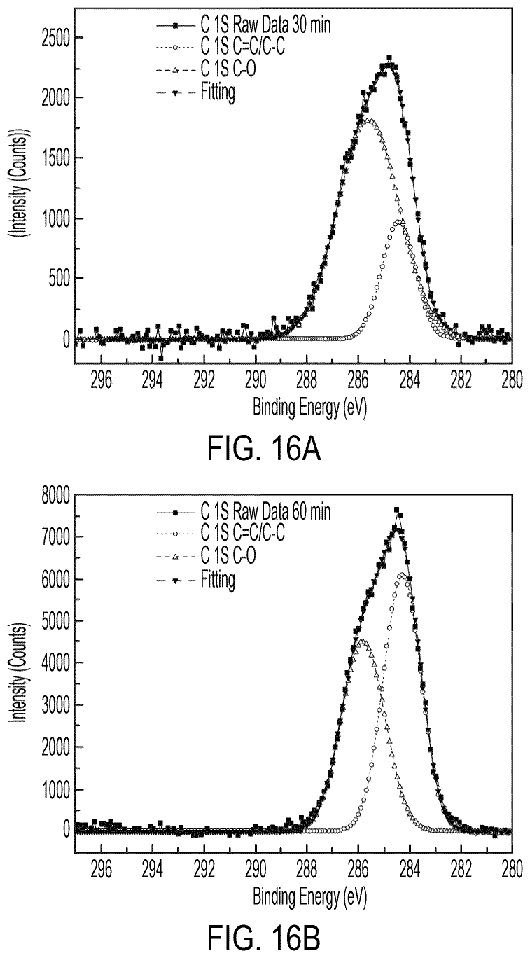

FIG. 16 shows the CIS XPS spectrum for the 30- (FIG. 16a) and 60-minute (FIG. 16b) samples, which show a single peak in the spectrum centered at 284.8 eV. In both samples the peak was deconvolved into 2 peaks centered at 284.2 eV and 285.8 eV, which correspond to C—C/C═C and C—O binding environments.

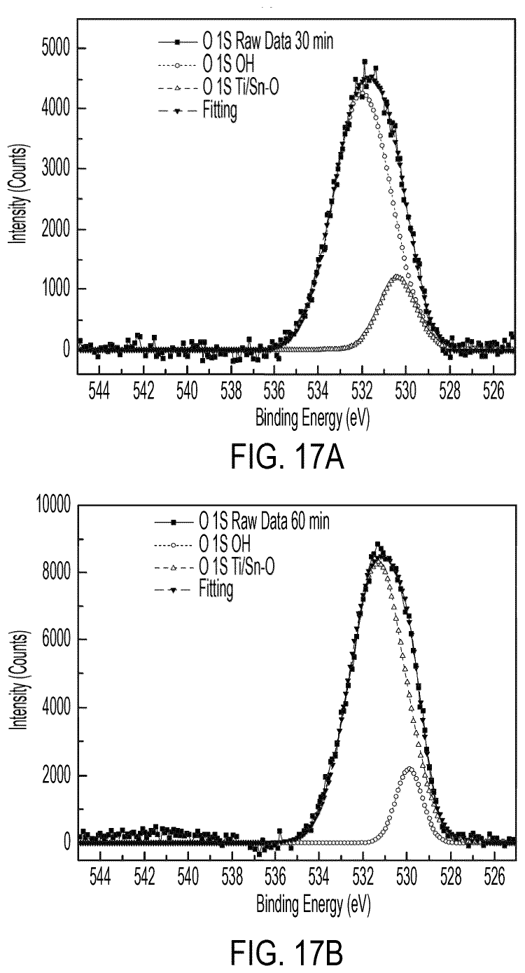

FIG. 17 shows the OlS XPS spectra for the 30- (FIG. 17a) and 60-minute (FIG. 17b) samples, which consisted of one peak centered at 531.3 eV. The peak was deconvolved into to individual peaks located at 530.0 and 531.8 eV. The peaks are representative of oxygen bound to a high oxidation state metal such as Ti or Sn with the oxygen in the 2-oxidation state and the presence of a hydroxyl species.

The electrochemical performance tests of the coated active material were conducted using the same tests and parameters as the SnO₂/TiO₂ (3:1) non-coated samples for comparison.

The active materials have been named in accordance with their deposition time: CVD 0-, 30-, and 60-min, with CVD 0-min pertaining to the SnO₂/TiO₂ (3:1) data from previous sections.

The coated material of 30- and 60-min samples were compared to the base sample of 0-min to analyze the effects of carbon-coating by CVD on the electrochemical performance of SnO₂/TiO₂ (3:1) metal-oxide as anode material.

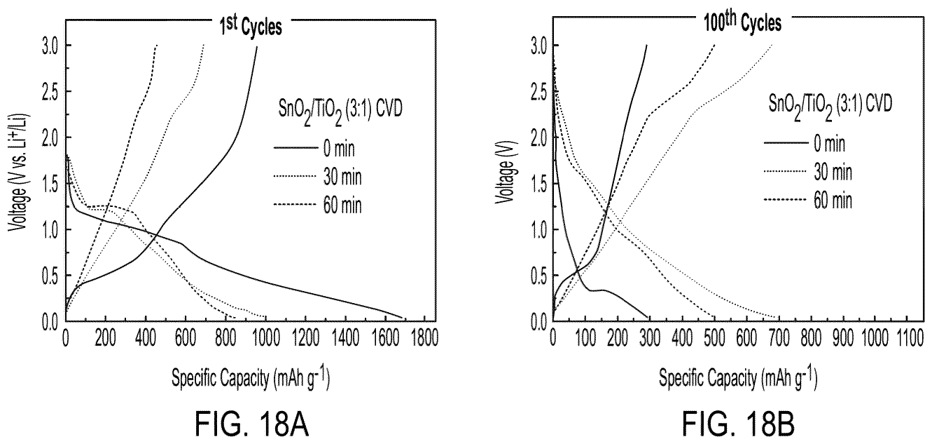

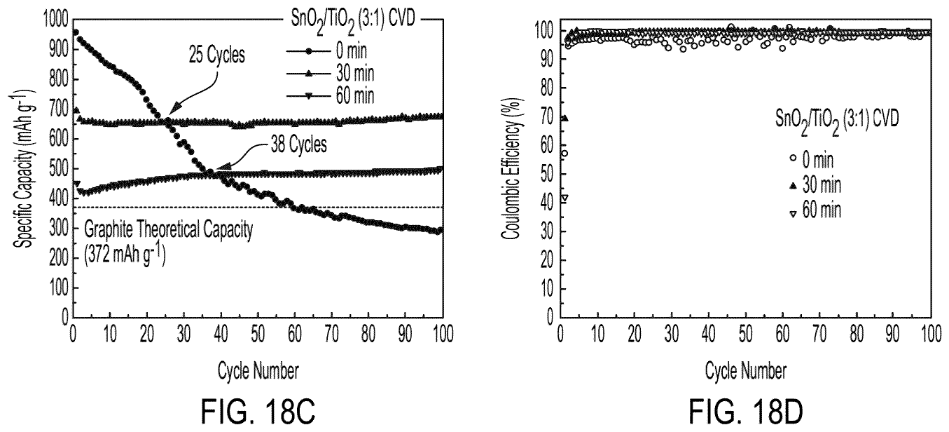

FIG. 18 shows the cycle performance of the CVD samples of 0-, 30-, and 60-min. FIG. 18a shows the first cycles of the CVD samples showing that 0-min had the highest irreversible specific capacity and initial charge-specific capacity with 1677 and 956 mAh g⁻¹ (43.0% loss), respectively. This is followed by 30-min with initial specific capacities of 1002 and 691 mAh g⁻¹ (31.0% loss). 60-min had the lowest initial specific capacities at 825 and 449 mAh g⁻¹ (45.6% loss). These results indicate a lower capacity from the original sample as the deposition time increases with a 40.3% reduction in initial discharge specific capacity for 30-min and a 50.8% reduction for 60-min. FIG. 18b illustrates the performances of the samples after 100 cycles and shows 30-min having the highest charge specific capacity with 653 mAh g⁻¹ (after 61 cycles) followed by 60-min with 499 mAh g⁻¹ and 0-min with 289 mAh g⁻¹. The CVD samples show great cycle performances with capacity retentions of 94.4% (projected to be 93.2% after 100 cycles) for the 30-min sample and 111% for the 60-min sample. The capacity retentions of the CVD samples are a vast improvement from the 30.3% of the original 0-min sample and indicate that carbon-coating by CVD provides better cycle performance despite initial capacity reduction. FIG. 9c shows the performances of the samples over each cycle. After 25 cycles, 30-min outperforms 0-min with a charge specific capacity of 652 mAh g⁻¹, and after 38 cycles 0-min's capacity fades below 60-min with a charge-specific capacity of 479 mAh g⁻¹. At the end of the test the 60-min sample outperforms the 0-min sample by 210 mAh g⁻¹ while the 30-min sample is projected to outperform the 0-min sample by 355 mAh g⁻¹. FIG. 9d shows the efficiency of each sample. The 30- and 60-min show great efficiency throughout their entire life cycle maintaining efficiencies above 99% after the 4^{th} cycle. Before the 4^{th} cycle, the 30-min sample shows an efficiency of 69% at the 1^{st} cycle due to the formation of the SEI layer but improves immediately to 97% on the 2^{nd} cycle and 99% on the 3^{rd} cycle. Additionally, the 60-min sample shows an efficiency of 42% at the 1^{st} cycle and improves to 95% on the 2^{nd} cycle and 98% on the 3^{rd} cycle. The efficiency results indicate an improvement on reversibility by the addition of carbon-coating by CVD regardless of the deposition time.

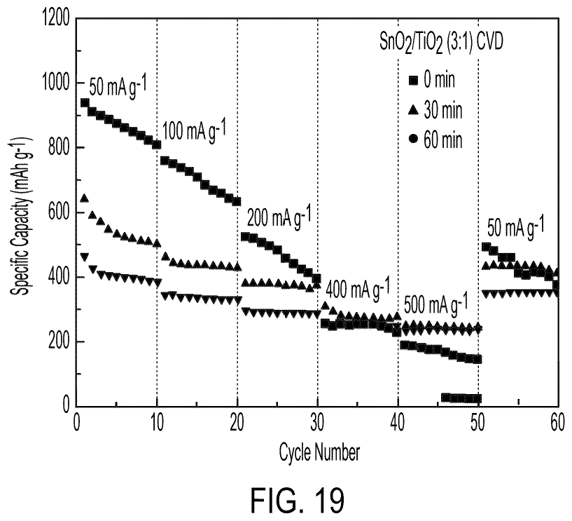

The rate performance for the coated active material was conducted using the current densities of 50, 100, 200, 400, 500, and 50 mA g⁻¹, and compared to the non-coated active material of 3:1 CVD 0-min. FIG. 19 shows that both CVD 30- and 60-min have a stable rate performance compared to their baseline sample of CVD 0-min. However, both 30- and 60-min samples have lower initial charge-specific capacities, 644 and 464 mAh g⁻¹, respectively, than the 0-min sample at 940 mAh g⁻¹. Additionally, losses throughout the current densities were lower for the 30- and 60-min sample. The 30-min sample had capacity losses of 22.0, 6.72, 1.31, 9.39, 3.23, and 5.08% from the initial to the final charge-specific capacity of each current density. Furthermore, the 60-min sample had the highest performance with capacity losses of 17.0, 4.07, 2.69, and 1.18% from 50 to 400 mA g⁻¹ and capacity gains of 0.42 and 2.01% from 500 to 50 mA g⁻¹. The 60-min also maintained a similar charge-specific capacity of 239 mAh g⁻¹ to the 30-min sample of 248 mAh g⁻¹ at 500 mA g⁻¹. As the current densities returned to 50 mA g⁻¹, the 30-min sample ended with a charge-specific capacity of 433 to 411 mAh g⁻¹ and a capacity retention of 63.8%, while the 60-min sample finished with a charge-specific capacity of 348 to 355 mAh g⁻¹ and a capacity retention of 76.3%. Compared with the 0-min sample, both the 30- and 60-min sample had more consistent rate performances and better capacity retentions. Also, both samples had higher charge specific capacities at 400 and 500 mA g⁻¹ than the 0-min sample. The rate performance data concludes that the addition of carbon-coating by CVD helps by preventing, or at the very least by delaying, the pulverization of the anode compared to the non-coated active material.

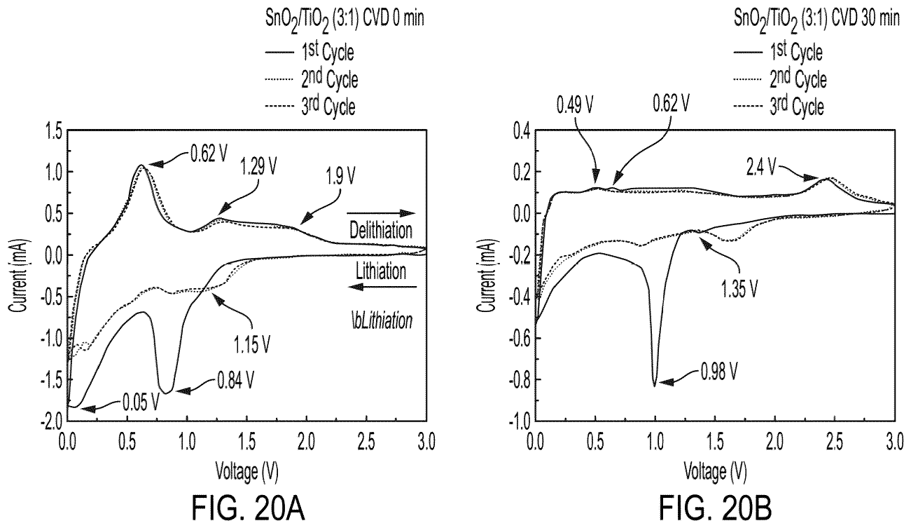

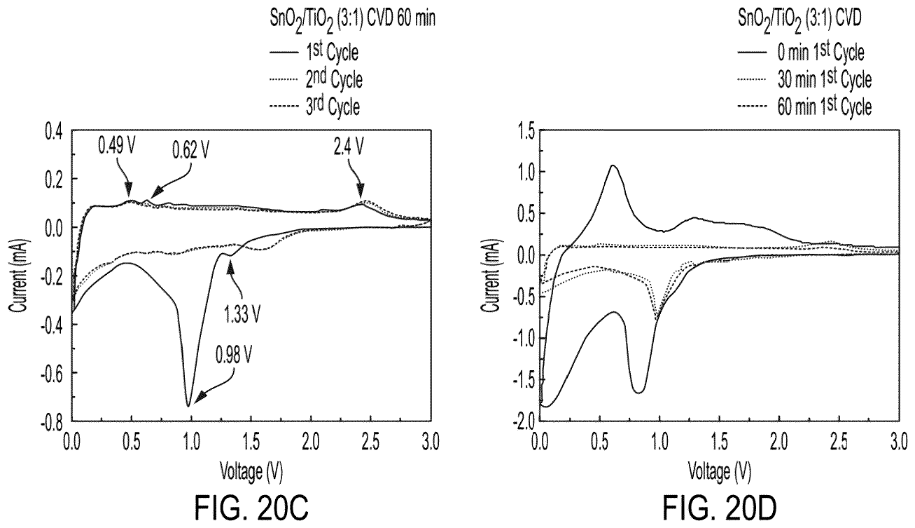

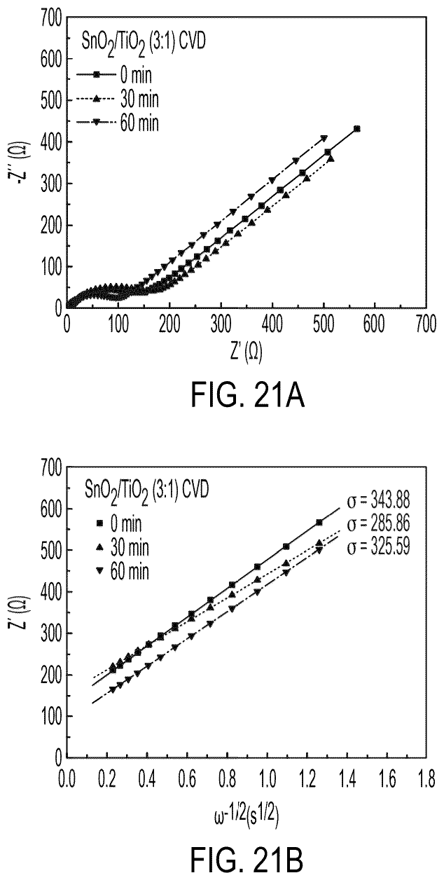

The lithiation/de-lithiation reactions of the CVD sample anodes were studied and compared using cyclic voltammetry tests. FIG. 20 shows the cyclic voltammogram of the first three cycles for SnO₂/TiO₂ (3:1) CVD (a) 0-min, (b) 30-min, and (c) 60-min, as well as (d) the first cycles of all three samples together. FIG. 11a shows the same results as FIG. 5c for comparison where the cathodic peaks are at 0.05, 0.84, and 1.15 V while the anodic peaks are at 0.62, 1.29, and 1.9 V. FIGS. 20b-c show the cathodic peaks in both 30- and 60-min samples at slightly higher voltages (lower currents) from the 0-min sample at 0.84 to 0.98 V (−1.84 to −0.83 mA) indicating the formation of the SEI layer and alloying of LiₓSn and 1.15 to 1.35 V (−0.43 to −0.1 mA) indicating the reduction of SnO₂. However, the anodic peaks are barely visible in both 30- and 60-min samples. This reaction is found in literature where the introduction of carbon to the sample causes the redox peaks to weaken. The anodic peaks at 0.49, 0.62, and 2.5 V are for both 30- and 60-min samples indicating that the SnO₂/TiO₂ (3:1) sample is coated entirely in carbon by CVD. The 0.49 and 0.62 V peaks can be attributed to the de-lithiation of LiₓSn and reoxidation of Sn while the 2.5 V corresponds in literature to the pyrolysis of the PAN binder during the heat treatment of the slurry. The subsequent cycles show overlapping signifying good cyclability and reinforces the data of both Coulombic efficiency and rate performance. FIG. 20d shows the 1^{st} cycles of the 0-, 30-, and 60-min samples to visually compare the redox peaks. It clearly shows the effects of the carbon-coating causes the peaks to weaken.

EIS tests were utilized to study the coated materail's electrochemical kinetics and compare them to the non-coated sample, 0-min. According to the results from FIG. 12, the 60-min sample has the lowest Rs, solution resistance, with 2.67Ω followed by the 0-min sample, 4.33Ω, and the 30-min sample, 5.42Ω. The polarization resistance, Rp, of the samples shows that the 60-min again has the lowest resistance with 91Ω followed by 0-min, 135Ω, and 30-min, 159Ω. Since the 60-min sample had the lowest resistances and the 30-min sample had the highest resistance, no correlation could be made about the effect carbon-coating has on the resistance of the samples. However, FIG. 12b show that the 30-min sample has the lowest Warburg constant, 6, with 285.86Ω s⁻² signifying high Li⁺ diffusion.

### CONCLUSION

In this work, CVD was used to coat SnO₂/TiO₂ short fibers with carbon which were directly used as anode materials in LIBs. The coated SnO₂/TiO₂ short fibers exhibited improved capacity and Coulombic efficiency to the buffering effect of amorphous carbon on the fibers. The CVD coating on the SnO₂/TiO₂ short fibers with 30 min coating time showed the best performance of the composite fibers compared to 60- and 90-min coating times.

While we have described a number of embodiments of this invention, it is apparent that our basic examples may be altered to provide other embodiments that utilize the compounds and methods of this invention. Therefore, it will be appreciated that the scope of this invention is to be defined by the appended claims rather than by the specific embodiments that have been represented by way of example.

### REFERENCES

1. Scrosati, B. and J. Garche, Lithium batteries: Status, prospects and future. Journal of Power Sources, 2010. 195(9): p. 2419-2430.
2. Manthiram, A., Materials Challenges and Opportunities of Lithium Ion Batteries. Journal of Physical Chemistry Letters, 2011. 2(3): p. 176-184.
3. Evarts, E. C., Lithium batteries To the limits of lithium. Nature, 2015. 526(7575): p. S93-S95.
4. Azam, M. A., et al., Recent advances of silicon, carbon composites and tin oxide as new anode materials for lithium-ion battery: A comprehensive review. Journal of Energy Storage, 2021. 33.
5. Li, H. Y., et al., Circumventing huge volume strain in alloy anodes of lithium batteries. Nature Communications, 2020. 11(1).
6. Chan, C. K., et al., High-performance lithium battery anodes using silicon nanowires. Nature Nanotechnology, 2008. 3(1): p. 31-35.
7. Szczech, J. R. and S. Jin, Nanostructured silicon for high capacity lithium battery anodes. Energy & Environmental Science, 2011. 4(1): p. 56-72.
8. Tzeng, Y., et al., Effects of In Situ Graphitic Nanocarbon Coatings on Cycling Performance of Silicon-Flake-Based Anode of Lithium Ion Battery. Coatings, 2021. 11(2).
9. Ying, H. J. and W. Q. Han, Metallic Sn-BasedAnodeMaterials: Application in High-Performance Lithium-Ion and Sodium-Ion Batteries. Advanced Science, 2017. 4(11).
10. Li, W. H., X. L. Sun, and Y. Yu, Si-, Ge-, Sn-BasedAnode Materialsfor Lithium-Ion Batteries: From Structure Design to Electrochemical Performance. Small Methods, 2017. 1(3).
11. Wang, Y., et al., Sn@CNT and Sn@C@CNT nanostructures for superior reversible lithium ion storage. Chemistry of Materials, 2009. 21(14): p. 3210-3215.
12. Lu, Y., et al., Centrifugally Spun SnO₂ Microfibers Composed ofInterconnected Nanoparticles as the Anode in Sodium-Ion Batteries. Chemelectrochem, 2015. 2(12): p. 1947-1956.
13. Chen, J. S. and X. W. Lou, SnO₂-BasedNanomaterials: Synthesis and Application in Lithium-Ion Batteries. Small, 2013. 9(11): p. 1877-1893.
14. Zoller, F., et al., Tin Oxide Based Nanomaterials and Their Application as Anodes in Lithium-Ion Batteries and Beyond. Chemsuschem, 2019. 12(18): p. 4140-4159.
15. Mukherjee, R., et al., Photothermally Reduced Graphene as High-Power Anodes for Lithium-Ion Batteries. Acs Nano, 2012. 6(9): p. 7867-7878.
16. Bhardwaj, T., et al., Enhanced Electrochemical Lithium Storage by Graphene Nanoribbons. Journal of the American Chemical Society, 2010. 132(36): p. 12556-12558.
17. Yoo, E., et al., Large reversible Li storage of graphene nanosheet families for use in rechargeable lithium ion batteries. Nano Letters, 2008. 8(8): p. 2277-2282.
18. Abouimrane, A., et al., Non-Annealed Graphene Paper as a Binder-Free Anode for Lithium-Ion Batteries. Journal of Physical Chemistry C, 2010. 114(29): p. 12800-12804.

The invention claimed is:

1. A method of making an electrode, comprising:
depositing, by chemical vapor deposition, a carbon coating on an electrode material comprising at least one of SnO₂ and TiO₂.

2. The method of claim 1, wherein the carbon coating comprises pyrolytic carbon.

3. The method of claim 1 or claim 2, wherein the electrode material comprises both SnO₂ and TiO₂.

4. The method of any one of the preceding claims, wherein the electrode material is a short fiber.

5. The method of claim 4, further comprising preparing the short fiber by centrifugal spinning of a mixture of a precursor solution comprising polyvinylpyrrolidone (PVP), SnO₂ and TiO₂.

6. The method of claim 5, further comprising heat treating the precursor solution after the centrifugal spinning to produce a fibrous mat.

7. The method of claim 6, further comprising calcinating the fibrous mat to produce the short fiber.

8. The method of claim 5, wherein the precursor solution comprises a SnO₂/TiO₂ ratio of about 3:1.

9. The method of any one of the preceding claims, wherein the chemical vapor deposition takes place for about 30 minutes.

10. The method of any one of claims 1-8, wherein the chemical vapor deposition takes place for about 60 minutes or less.

11. The method of any one of the preceding claims, wherein the calcinating comprises heating the fibrous mat to about 700° C. for about 3 hours.

12. The method of any one of the preceding claims, wherein the electrode material is heated to about 1000° C. prior to the chemical vapor deposition of the carbon coating.

13. The method of any one of the preceding claims, wherein the chemical vapor deposition comprises contacting the electrode material with methane gas.

14. The method of any one of the preceding claims, wherein the carbon coating has a thickness of about 5 nm to about 50 nm.

15. The method of any one of the preceding claims, wherein the carbon coating has a thickness of about 50 nm or less.

16. The method of any one of the preceding claims, wherein the short fiber has a length of about 1 μm to about 4 μm.

17. The method of any one of claims 1-15, wherein the short fiber has a length of about 4 μm or less.

18. The method of any one of the preceding claims, wherein the electrode material is an anode.

19. An anode made by the method of any one of the preceding claims.

20. A lithium ion battery comprising an anode made by the method of any one of claims 1-18.

21. A method of making an electrode material comprising SnO₂ and TiO₂, the method comprising centrifugal spinning of a mixture of a precursor solution comprising polyvinylpyrrolidone (PVP), SnO₂ and TiO₂.

22. The method of claim 21, further comprising heat treating the precursor solution after the centrifugal spinning to produce a fibrous mat.

23. The method of claim 22, further comprising calcinating the fibrous mat to produce the electrode material.

24. The method of claim 23, wherein the calcinating comprises heating the fibrous mat to about 700° C. for about 3 hours.

25. The method of any one of claims 21-24, further comprising depositing a layer of carbon on the electrode material.

26. The method of any one of claims 21-25, wherein the layer of carbon is a pyrolytic layer of carbon.

27. The method of any one of claims 21-26, wherein the depositing comprises depositing by chemical vapor deposition.

28. The method of any one of claims 21-27, wherein the electrode material is a short fiber.

29. The method of claim 28, wherein the short fiber has a length of about 1 μm to about 4 μm.

30. The method of claim 28, wherein the short fiber has a length of about 4 μm or less.

31. The method of any one of claims 21-30, wherein the electrode material is an anode.

32. An anode made by the method of any one of claims 21-30.

33. A lithium ion battery comprising an anode made by the method of any one of claims 21-30.

34. An electrode material comprising SnO₂ and TiO₂, wherein the electrode material comprises a coating of pyrolytic carbon.

35. The electrode material of claim 34, wherein the electrode material is a short fiber.

36. The electrode material of claim 34 or claim 35, wherein the carbon coating has a thickness of about 5 nm to about 50 nm.

37. The electrode material of any one of claims 34-36, wherein the carbon coating has a thickness of about 50 nm or less.

38. An electrode material comprising SnO₂ and TiO₂, wherein the electrode material is in a nanobelt form; optionally wherein the nanobelt comprises a coating of pyrolytic carbon.
